(19) United States
(12) Patent Application Publication
(10) Pub. No.: US 2026/0007187 A1
(43) Pub. Date: Jan. 8, 2026

(54) ATOMISING DEVICE WITH HEATING ELEMENT MADE OF LASER-INDUCED CARBON FOAM

(71) Applicant: INTEGRATED GRAPHENE HOLDING LIMITED, Stirling (GB)

(72) Inventors: Marco CAFFIO, Stirling (GB); Oliver SEMPLE, Stirling (GB); Darren CAIRNS, Stirling (GB); Peter LANGLEY, Stirling (GB)

(21) Appl. No.: 19/328,169

(22) Filed: Sep. 14, 2025

Related U.S. Application Data
(63) Continuation of application No. PCT/GB2024/050687, filed on Mar. 14, 2024.

(30) Foreign Application Priority Data
Mar. 14, 2023 (GB) 2303732.8

(51) Int. Cl. A24F 40/70; B29C 35/08; B29K 79/00; B29L 31/00; H05B 3/14

(52) U.S. Cl. CPC A24F 40/70; B29C 35/0805; B29C 2035/0838; B29K 2079/08; B29L 2031/779; H05B 3/145; H05B 2203/017

(57) ABSTRACT

A method of manufacturing a component for an atomising device is disclosed; the component is made substantially of carbon foam. The method includes the step of using a high temperature process generated by a laser beam directed at a carbon-based pre-cursor material, such as a polymer or polyimide sheet material, to manufacture the carbon foam component. The component is electrically conductive, non-metallic and porous to e-liquid. The component can be a carbon foam based component that functions as both a wicking element and also a heating element.

### CROSS-REFERENCE TO RELATED APPLICATIONS

This application is a bypass continuation of International Application No. PCT/GB2024/050687, filed on Mar. 14, 2024, which claims priority to GB Application No. GB 2303732.8, filed on Mar. 14, 2023, the entire contents of which being fully incorporated herein by reference.

### FIELD OF THE INVENTION

This invention relates to an atomising device with a heating element component made of laser-induced carbon foam, such as turbostratic twisted multilayer carbon foam. The heating element is suitable for use as a heating element in a broad range of atomising devices, including electronic nicotine devices (‘ENDs’) such as vaping devices and heat-not-burn sticks, and other devices, including medical inhalation devices, where a substance has to be heated rapidly to generate a safe, inhalable vapour.

### BACKGROUND TO THE INVENTION

Vaping devices heat a liquid (typically containing nicotine, propylene glycol, vegetable glycerine and flavourings) to generate an inhalable vapour; the heater is typically a metallic wire or metallic mesh which is resistively heated using a power source delivering 4V to 5V. A wicking structure feeds liquid from a small (typically 2 mL; often filled with a fibreglass type foam) reservoir in the device to the heating element; a cotton or semi-synthetic fibre wick is commonly used; ceramics are also well established. One significant disadvantage to using metallic heaters is that the inhaled vapour often includes some metals (e.g. nickel, chromium), which can have undesirable health consequences. For ceramics, the release of silica dust is a potential hazard. Whilst vaping devices are not without risk, their use is widely understood to be very considerably safer than smoking combustible cigarettes.

Heated tobacco products are also considerably safer than combustible cigarettes: a cigarette-like ‘stick’ (made up of a tobacco leaf derived substance, formed into a ‘plug’) also contains a thin ferromagnetic metallic strip, coated with stainless steel, that acts as an inductive target or susceptor. The ‘stick’ is placed into a portable heating device, which inductively heats the metallic susceptor strip to no more than about 350 C. That in turn heats the plug, generating an inhalable vapour. The vapour may, as with vaping devices, contain very small quantities of metals (although at a significantly lower level than vaping devices).

Graphene, has for many years been of great interest for applications including biosensors, electrochemical sensing systems, supercapacitors, electrodes, and fuel cells. Known methods of producing 3D graphene include the laser induced graphene production described in WO 2019/038558; when a suitable carbon pre-cursor material, such as polyimide film, is positioned on a supporting substrate, and irradiated with a CO₂ laser, then 3D graphene forms at the surface of the exposed polyimide film. Experience has shown that the thickness of the 3D graphene produced by this method is less than 50 μm; further, the 3D graphene itself can be brittle and adhere poorly to an underlying substrate and may flake off that substrate. It is hence unsuited to many applications. Whilst there has been some speculation that graphene could be used as part of a heater for a vaping device, the traditional methods of manufacturing graphene (e.g. chemical vapour deposition) make large scale use of graphene for this purpose uneconomic.

A note on terminology used in the carbon nanostructure field: if we just take the term ‘graphene’, there are many different forms of ‘graphene’; for example, the literature describes monolayer graphene, bilayer graphene, turbostratic graphene, graphene superlattices, graphene fiber, 3D graphene, graphene aerogel, crumpled graphene, and many other forms. This presents a definitional challenge because use of a specific term (e.g., ‘3D graphene’) might imply a limitation to only that specific form of graphene. Further, The IUPAC (International Union for Pure and Applied Chemistry) recommends use of the name “graphite” for the three-dimensional material, and “graphene” only when the reactions, structural relations or other properties of individual layers are discussed.

In this specification, we therefore use the term ‘carbon foam’ as a generalised term, and this term should be expansively construed to cover any carbon nanostructure, such as 3D carbon material foam, including turbostratic twisted multilayer 3D carbon material foam.

One instance of the term ‘carbon foam’ refers to a material that is manufactured using the methods described in this specification; this material has properties that are somewhat distinct from conventional graphene or conventional graphene foam. For example, graphene foam has several characteristics: it is hydrophobic, with low wettability. Raman analysis of a typical graphene foam reveals the following signatures: absence of a D peak; the 2D peak is higher than the G peak; the peak D: peak G ratio is close to zero. As we will describe in more detail below, the carbon foam generated in an implementation of this invention shares none of these characteristics; it is hydrophilic, with a contact angle below 20°; it lacks the tell-tale Raman signature of graphene: it shows a significant D peak; the 2D peak is significantly less than the G peak; the peak D: peak G ratio is significantly above zero. In appearance and Raman signature, it appears closer to carbon nano-onion material. The term ‘carbon foam’ hence also includes within its scope materials that are carbonaceous nanostructures, such as carbon nano-onion, carbon nano-horn, carbon nano-tubes, carbon nano-dots, nanodiamonds and fullerene, or combinations of any of these. ‘Carbon foam’ can hence refer to a non-graphene material.

### SUMMARY OF THE INVENTION

One aspect of the invention is a method of manufacturing an atomising device; the atomising device includes a heating component that is made substantially of carbon foam. The method includes the step of using a high temperature process generated by a laser beam directed at a carbon-based pre-cursor material, such as a polymer or polyimide sheet material, to manufacture the carbon foam component. The component is electrically conductive, non-metallic and porous to an atomisable liquid or capable of wicking the atomisable liquid. The component can be a carbon foam based component that functions as both a liquid wicking element and also a heating element that atomises the liquid.

As noted earlier, the heating element is suitable for use as a heating element in a broad range of atomising devices, including electronic nicotine devices (‘ENDs’) such as vaping devices and heat-not-burn sticks, and other devices, including medical inhalation devices, where a substance has to be heated rapidly to generate a safe, inhalable vapour. The heating element is also suitable for heating non-liquids; it does not then have to be porous to an atomisable liquid or capable of wicking the atomisable liquid. One aspect of the invention is a method of manufacturing a heating element that serves as an inductively heated carbon foam susceptor strip in a tobacco ‘stick’, as used in a heat-not-burn or THP (tobacco heated product); a related aspect of this invention is the tobacco ‘stick’ that includes the carbon foam susceptor strip. Normally, an inductively heated susceptor strip is metallic, but this risks introducing metallic contaminants into the inhaled vapour.

A similar challenge is faced with drug medication atomisers, such as metered dose inhalers and soft mist inhalers; some of these could be enhanced if a medication, in either liquid or powder form, is heated—e.g. to atomise or nebulize the medication or sublimate the medication directly into the gas phase. But conventionally the heater would be metallic and would hence risk introducing metallic contaminants into the inhaled vapour. Another aspect of the invention is a method of manufacturing a carbon foam heating element for a drug medication atomiser, and a related aspect is the drug medication atomiser that includes this carbon foam heating element.

Further aspects and features of the invention are defined in the Claims.

### BRIEF DESCRIPTION OF THE FIGURES

The invention will be described with reference to implementations of the invention shown in the following Figures:

FIGS. 1-6 schematically show the ‘Dual Laser’ process used to create carbon foam when a polyimide (PI) film, acting as the carbon pre-cursor, is positioned on a substrate.

FIG. 7 is a scanning electron image showing the unique surface morphology of the carbon foam achieved using the Dual Laser method (×250).

FIG. 8 is a scanning electron image showing the surface of conventional laser induced graphene.

FIGS. 9-14B schematically show the Dual Laser process used to create carbon foam when a PI film, acting as the carbon pre-cursor, is not positioned on a substrate.

FIGS. 15A and B are Raman analyses of a carbon foam sample made by the Dual Laser process.

FIG. 15C is a Raman analysis of carbon nano-onion material.

FIG. 16 are scanning electron images showing Dual Laser carbon foam and conventional graphene.

FIG. 17 is a schematic of a high-speed reel to reel or reel to sheet manufacturing system for Gii carbon foam.

FIGS. 18-22 are scanning electron images showing Dual Laser carbon foam at various magnifications.

FIG. 23 is a scanning electron image of a carbon nano-onion material made using a conventional process.

FIG. 24 shows the Raman shifts for eight sheets of carbon foam made using the Dual Laser process.

### Vaping Device Figures

FIG. 25 is a schematic cross section of a conventional vaping device with a metal mesh heater.

FIG. 26 is a schematic cross section of the FIG. 25 vaping device, with a carbon foam heater replacing the mesh heater.

FIG. 27 is a schematic cross section through a carbon foam integrated wick and heater.

FIG. 28 is a schematic perspective view of the FIG. 27 carbon foam integrated wick and heater when rolled up into a cylinder.

FIG. 29 is a schematic cross section through a carbon foam structure with parallel non-planar wick and heater sections, with internal liquid micro-channels formed in the PI substrate to join the wick and heater sections.

FIG. 30 is a schematic plan view of a carbon foam co-planar wick and heater with internal liquid micro-channels formed in the PI substrate joining the co-planar wick and heater.

FIG. 31 is a schematic cross section of the FIG. 30 structure.

FIG. 32A is a schematic cross section through a tip or pod for a vaping device, with a carbon foam, combined co-planar wick and heater.

FIG. 32B is a perspective view of the FIG. 32A pod.

FIG. 33 is a schematic cross section through a tip or pod for a vaping device, with a carbon foam, combined non co-planar wick and heater.

FIG. 34 is a schematic cross section through a tip or pod for a vaping device, with a carbon foam, combined non co-planar but parallel wick and heater.

Note that Gii is a trademark of the patent proprietor. ‘Gii’ refers generally to the carbon foam made using the Dual Laser process.

### INDEX TO FIGURES

### Vaping and THP Devices

20 cylindrical metal mesh heating element
21 cylindrical flexible sleeve
22 e-liquid reservoir
23 apertures in the sleeve 21
24 vapour creation chamber/
26 vapour channel
27 vapour outlet in mouthpiece
28 top silicone seal
29 bottom silicone seal
30 plastic case enclosing the liquid reservoir 22
40 carbon foam heating element
50 carbon foam region
51 liquid wicking carbon foam section
52 heating carbon foam section
53 high temperature polyimide film substrate
54 silk screen printed power electrodes
55 liquid movement direction arrow
56 liquid micro-channel(s)
57 electrical connector

### Dual Laser Process

110 IR laser
120 IR laser beam
125 CO₂ laser
130 interior of PI film
140 PI film
150 substrate
160 sub-surface carbon foam region
170 disorganised, amorphous, non-graphene material below the sub-surface carbon foam region
180 expanded region of disorganised, amorphous, non-graphene material above the sub-surface carbon foam region
185 unique surface morphology of the exposed carbon foam region

### DETAILED DESCRIPTION

We organise this Detailed Description section as follows:
SECTION A: MANUFACTURING CARBON FOAM
SECTION B: KEY FEATURES A-K OF THE CARBON FOAM MANUFACTURING PROCESS
SECTION C: CARBON FOAM USED IN VAPING AND THP (TOBACCO HEATED PRODUCT) DEVICES

In this Section A, we explain how carbon foam (and related carbon foams) may be manufactured. Reference may be made to WO 2023/118866, the contents of which are incorporated to the maximum extent permissible. One implementation of this carbon foam is called Gii® carbon foam.

### Section A: Manufacturing Carbon Foam

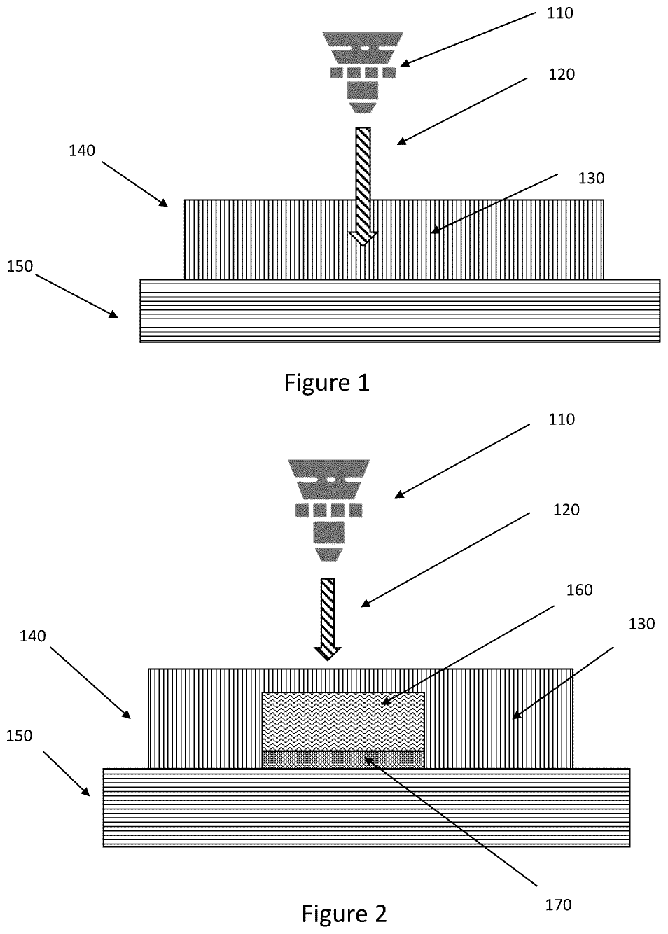

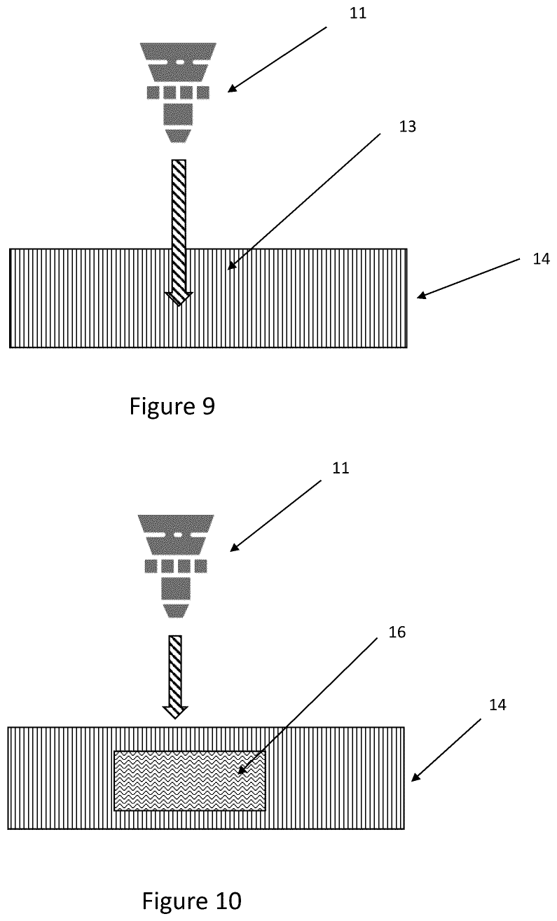

We will start with a simplified, schematic walk-through of implementations of the invention. We give two walk-throughs; the first (FIGS. 1-6) will describe at a high level the carbon foam production process when the carbon pre-cursor (e.g. polyimide (PI) film, such as Kapton® film in this case) is mounted on a substrate; the second walk-through (FIGS. 9-14) covers the carbon foam production process when the polyimide film is not mounted on a substrate. In each case, we use a Dual Laser process; we will explain what the term means below.

In the first stage, (see FIG. 1), laser 110 with wavelength A irradiates with laser beam 120 the interior 130 of polyimide film 140, positioned on a substrate 150 suitable for the end application. This laser can be a pulsed IR laser that delivers IR radiation with a 1064 nm wavelength.

As shown in FIG. 2, the laser 110 with wavelength A is tuned so that a sub-surface region 160 is converted to carbon foam. The focus of laser A moves progressively through the interior 130 of the polyimide film 140 to create the entire carbon foam region 160. The carbon foam region 160 can be approximately 50 μm or greater in depth or height-far taller than is possible with other methods. Note that there is no carbon foam created on the exposed surface (i.e. the surface that the laser beam is incident on) of the polyimide film 140 at any time. The region above the carbon foam 160 (i.e. closer to the laser than the carbon foam region 160) is not converted to carbon foam. The region 170 below the carbon foam region 160 (i.e. the lower surface of the PI film) is also not converted to carbon foam but is instead converted to a disorganised, amorphous non-graphene material that adheres to the underlying substrate 150.

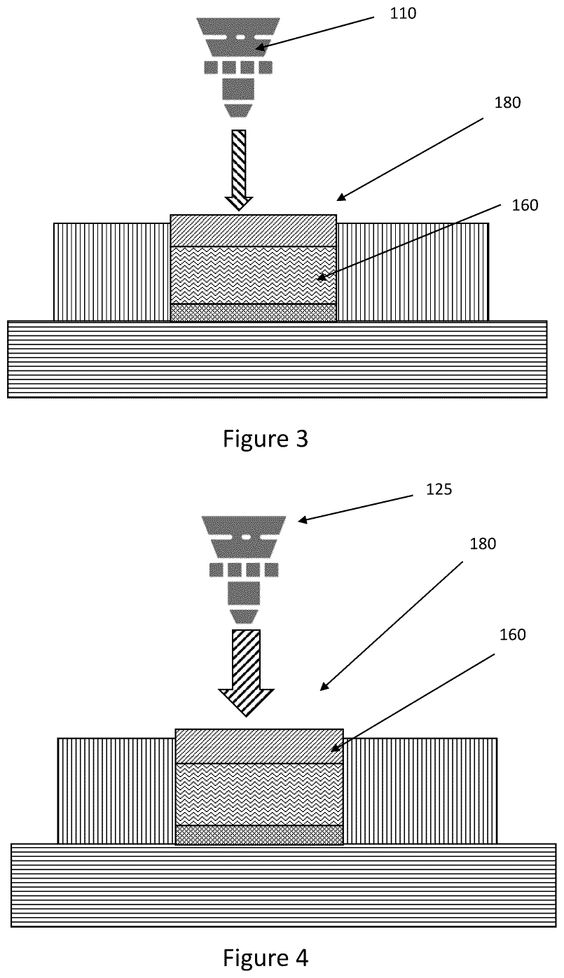

FIG. 3 shows that laser 110 with wavelength A causes a physical expansion at the region 180 above (i.e. closer to the laser than the carbon foam region 160) the internal carbon foam zone 160 due to trapped gasses. This region 180 is not 3D graphene, nor is it a polymer; it is a disorganised, amorphous material.

In a second stage, a laser with wavelength B is now tuned on the disorganised, amorphous material region 180 above the carbon foam region 160, as shown in FIG. 4. This can be a CO2 laser 125 with a 10.6 μm wavelength.

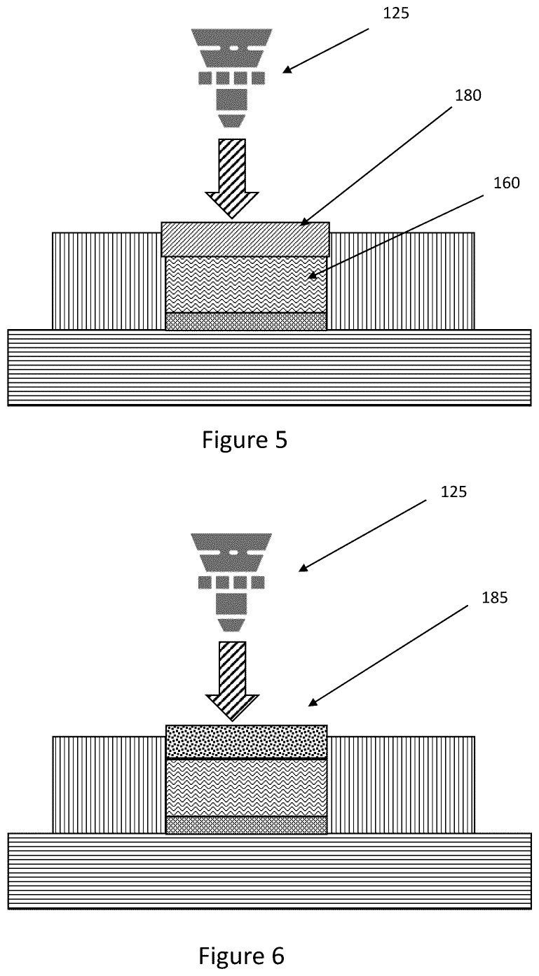

This laser 125 with wavelength B, as shown in FIG. 5, ablates some or all of the region 180 above the carbon foam region 160, exposing at least some of the underlying carbon foam region 160.

The laser 125 with wavelength B also gives the underlying carbon foam region a unique surface morphology 185, as shown in FIG. 6.

We refer to the process described in FIGS. 1-6 as a ‘Dual Laser process’.

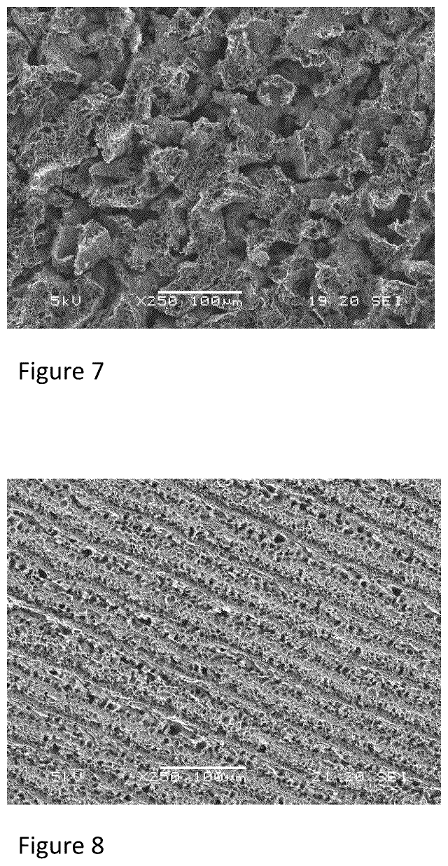

FIG. 7 is a scanning electron image showing the unique surface morphology achieved using the Dual Laser method (×250). In this case, the carbon source was irradiated first with IR radiation of a wavelength of 1064 nm from a pulsed IR laser, with the radiation focused into the carbon source and at progressive depths within the carbon source, and then the carbon source was irradiated with a laser beam at wavelength of 10.6 μm from a CO₂ laser. The approximate thickness of the carbon foam layer in this image is 220 μm.

The contrast with the surface morphology achieved using a conventional LIG (laser induced graphene) method (×250), shown in FIG. 8, is clear: there are clear raster lines, and the folding is less convoluted. The thickness of this layer of carbon foam is less than 50 μm.

From the FIG. 7 images, we may infer that the material created using the Dual Laser process does not have a surface morphology similar to conventional graphene foam; whilst it appears to be a turbostratic twisted multilayer 3D carbon-based material with a foam like structure, it is not necessarily what one would normally describe as ‘graphene’, in the conventional sense.

In the preceding walk-through (FIGS. 1-6), we looked at the Dual Laser process when the carbon pre-cursor material (the polyimide film) is mounted on a substrate. In the following FIGS. 9-14, we will look at the Dual Laser process when the polyimide film is not mounted on a substrate. The manufacturing processes we describe in detail later for the two implementations called Gii-Cap (a supercapacitor) and Gii-Sens (a sensor) use a standard 220 mm×180 mm sheet of polyimide film that is not mounted on a substrate; this size can be accommodated in a standard laser scanning device, of the sort typically used for laser engraving, laser cutting and laser plotting that traces out a path defined by a standard CAD program. The manufacturing processes also uses a standard flatbed screen printing device, and a standard conveyor dryer, again readily compatible with different sizes of thin PI film. Other sizes of polyimide sheet can be accommodated.

As described previously, laser 110 with wavelength A (e.g. IR laser) irradiates the interior 130 of PI film 140; the film 140 is now not mounted on a substrate, as shown in FIG. 9. It can be a sheet that is supported at its edges, or rests temporarily upon a surface, or forms part of a reel of PI film when a continuous manufacturing (e.g. reel to reel or reel to sheet) system is used (see Feature L).

The laser 110 with wavelength A is tuned so that a sub-surface region 160 is converted to carbon foam, as shown in FIG. 10. The focus moves progressively through the film 140 to create the entire carbon foam region 160. The carbon foam region 160 can be approximately 50 μm or greater in height-far deeper or taller than is possible with other methods.

There is no 3D graphene created on the exposed surface of the polymer film at any time. The region above the carbon foam is not converted to 3D graphene.

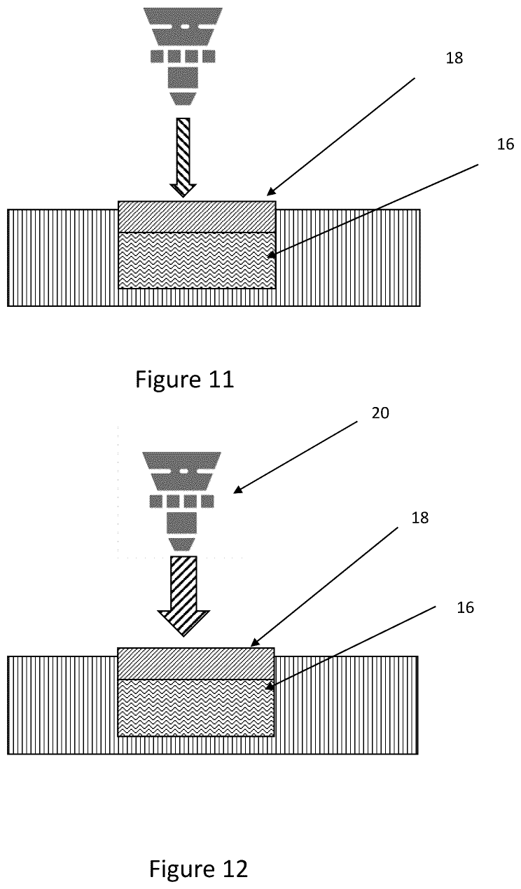

As shown in FIG. 11, there is a physical expansion of the region 180 above the internal carbon foam zone 160 due to trapped gasses. This region is not 3D graphene, nor a polymer; it is a disorganised, amorphous material.

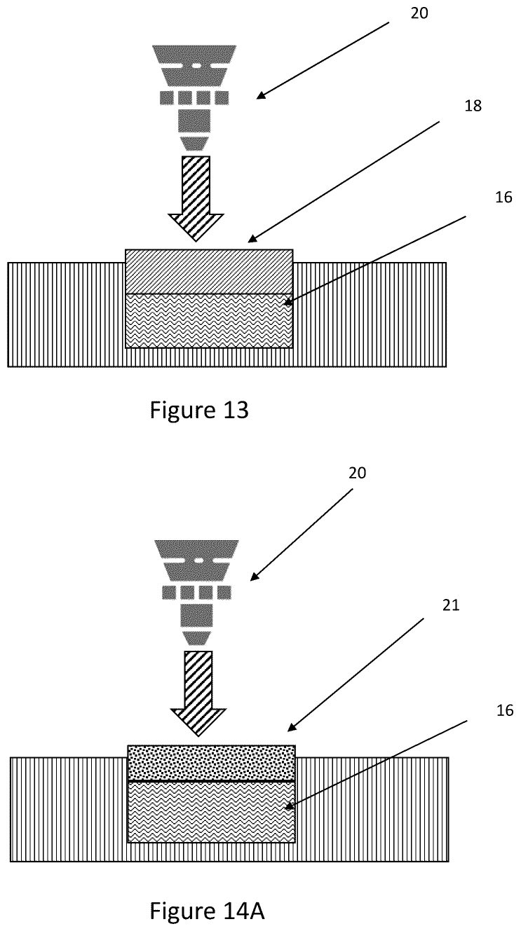

A laser 125 with wavelength B (e.g. CO₂) is now tuned on the region 180 above the carbon foam, as shown in FIG. 12. The laser 125 with wavelength B ablates the region 180 above the carbon foam region 160, exposing at least some of the underlying carbon foam 16, as shown in FIG. 13.

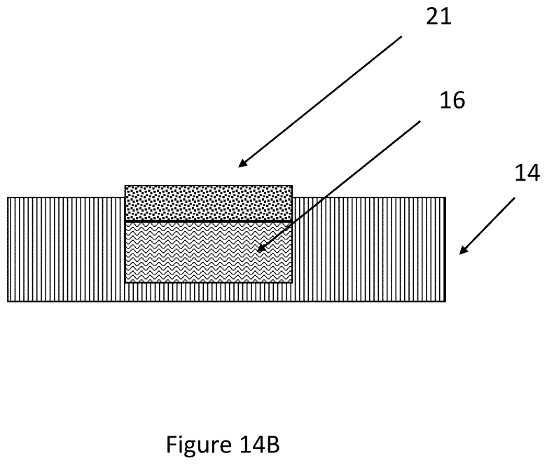

Just as when the polyimide film 140 is mounted on a substrate, the laser 125 with wavelength B also gives the underlying carbon foam 160 a unique surface morphology 185, as shown in FIG. 14.

Some implementation specifics for this Dual Laser approach to carbon foam production now follow: in one example, a Nd: YAG solid state laser is the wavelength A laser and is positioned so that the IR laser radiation beam (wavelength of 1064 nm) produced by the solid-state laser impacts the polyimide layer perpendicular to the layer. Optics focus the IR laser radiation laser beam to a volume of minimum beam convergence within the polyimide layer.

In an encapsulated or sub-surface region or locus around the minimum beam convergence the interaction of the laser light and the polyimide results in carbonization of the carbon source. This carbonization results in the production of carbon foam, such as a twisted or turbostratic multilayer carbon foam, in the encapsulated or sub-surface region and results in the production of a layer of a disorganised, amorphous non-graphene substance at the surface of the polyimide film.

While maintaining the laser beam focused at a particular depth within the polyimide layer, the laser is scanned laterally over the polyimide layer. In this way a path, wholly within the polyimide carbon source, is tracked and is converted to carbon foam. The polyimide is hence carbonized to a carbon foam in a pattern which corresponds to the path tracked by the scanned, focused IR laser beam.

In one set-up, the Nd: YAG IR laser was pulsed at a frequency of 80 kHz and the laser beam was scanned across the surface at a speed of 9.4 cm/s. Other embodiments utilised different parameters. For example, a pulse frequency of 50 kHz and a scan speed of 35.5 cm/s were also utilised to successfully produce carbon foam. The laser power is within a typical working range of 8-20 watts, with 12 W optimum; the laser focal distance is within a typical working range of 50 mm-400 mm.

Once a predetermined area within the polyimide layer has been irradiated in the above manner by the focused IR laser beam, the depth of the encapsulated or sub-surface region or locus in the polyimide is changed and the IR laser beam is again scanned over an area, in this case over the same predetermined area. A standard computer-controlled laser scanning system can be used that controls the X-Y position of a laser over the polyimide film. It may be necessary to pass the focused IR laser radiation over the same area more than once to produce carbon foam. In this implementation, the focused IR laser also irradiates adjacent, but not substantially overlapping, areas. This process of irradiating the carbon source with the focused IR laser radiation at different focus depths is repeated until the desired depth of the polyimide layer has been exposed to the IR laser radiation and carbon foam has been formed in the encapsulated or sub-surface region. The surface layer is however a disorganised, amorphous, non-graphene substance.

In the second step, the polyimide layer is exposed to radiation from a CO2 laser to perform the ablation step, to expose at least some of the underlying carbon foam and to give the exposed carbon foam a particular surface morphology. The radiation from the CO2 laser is scanned across the surface of the treated carbon source at a speed of 19 cm/s to match the pattern or area which had been irradiated with the IR laser. Other embodiments utilised different parameters. For example, a pulse frequency of 50 kHz and a scan speed of 35.5 cm/s were also utilised to successfully reveal the underlying carbon foam. The laser power is within a typical working range of 8-20 watts, with 12 W optimum; the laser focal distance is within a typical working range of 50 mm-400 mm.

As noted above, the CO₂ laser ablates the surface layer disorganised, amorphous, non-graphene substance, exposing the underlying carbon foam and altering the surface morphology of that carbon foam to generate an exposed, carbon foam with a greater number of defects compared to standard laser induced graphene; this gives the carbon foam exceptionally useful properties that are superior to standard laser induced graphene, as noted earlier.

Varying the laser parameters for either or both of the lasers (e.g. IR and the CO₂ lasers), such as power, focus, wavelength, scanning speed, varies the carbon foam material properties, enabling carbon foam to be produced with properties that are optimised for different applications.

One useful property of the exposed carbon foam made by the Dual Laser process is a high degree of wettability: the contact angle can be less than 20°, making this carbon foam hydrophilic, in contrast with conventional graphene foam, which has a contact angle between 70° and 150°, making it hydrophobic. The hydrophilic property of the carbon foam produced by the Dual Laser process is highly relevant for vaping applications, since it enables fast and even distribution of e-liquid.

Another useful property of the exposed carbon foam made by the Dual Laser process is a high degree of antifouling: the carbon foam could be useful in applications where the build-up of contaminants or residues can harm the performance or lifetime of an element (e.g. heating elements in electronic cigarettes and HNB devices as described in Section C below; electrodes); the exposed carbon foam made by the Dual Laser process element can be used for the element, leading to an enhanced performance or lifetime.

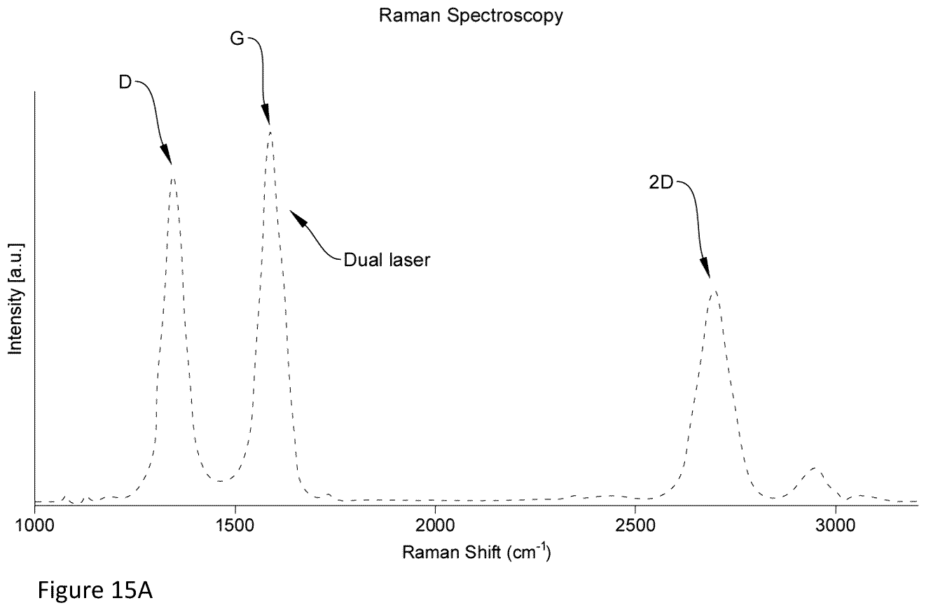

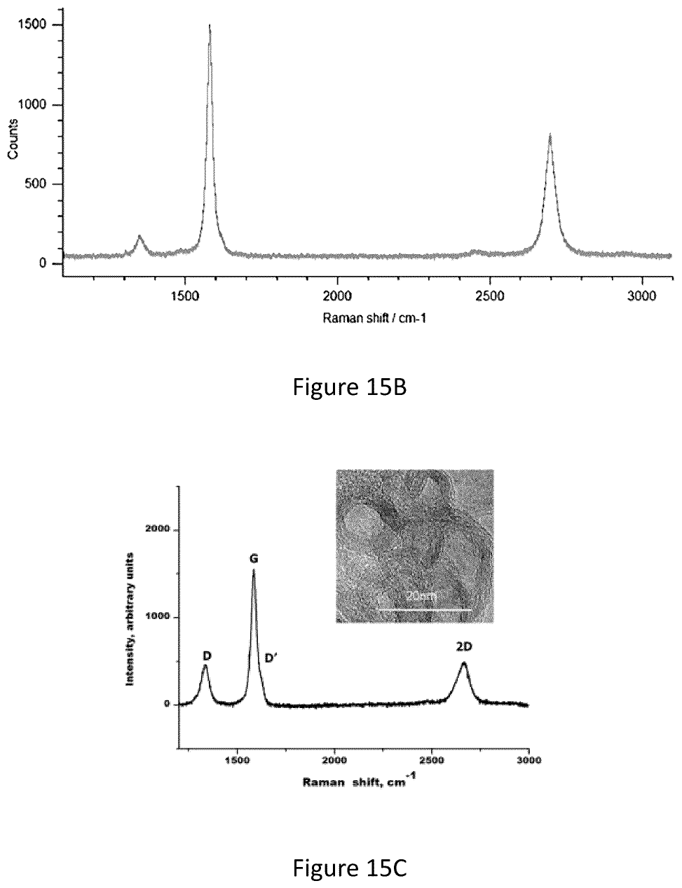

The Raman spectrum of carbon foam made by the Dual Laser process is shown in FIG. 15A has three principal peaks. In particular, the D peak at around 1344 cm⁻¹ is characteristic of the presence of lattice defects and the G peak at around 1577 cm⁻¹ is characteristic of sp² carbon hybridisation, with the presence of distorted six-fold carbon rings. The 2D peak at around 2685 cm⁻¹ is characteristic of second order transitions in the 3D graphene and the absence of a doublet structure here indicates a lack of planar AB stacking which would be found in multilayer 2D graphene or graphite. Fitting the 2D peak with a single Lorentzian peak (having a full width at half maximum of 67 cm⁻¹) centred at 2685 cm⁻¹ indicates that there are only one, or a few, carbon-foam-like layers present in the 3D carbon formed with the two methods. Analysis of the D/G peak ratio (0.85) for the Dual Laser process, indicates a higher defect density compared to a conventional laser-induced graphene process (0.67) that uses a single laser step, as shown in Table 1 below.

TABLE 1

| Process | D/G | 2D/G | D/D |
|---|---|---|---|
| Dual Laser | 0.85 ± 0.1 | 0.95 ± 0.12 | 3.7 ± 1.3 |
| Conventional single laser | 0.67 ± 0.13 | 0.75 ± 0.05 | 2.6 ± 0.22 |

As we noted earlier, Raman analysis of a typical graphene foam reveals the following signatures: absence of a D peak; the 2D peak is higher than the G peak; the peak D: peak G ratio is close to zero. The carbon foam generated in an implementation of the invention shares none of these characteristics; it is highly hydrophilic, with a contact angle below 20°; it lacks the tell-tale Raman signature of graphene: FIG. 15A shows, for the material made by the Dual Laser process: presence of a D peak; the 2D peak is lower than the G peak; the peak D: peak G ratio is above zero. FIG. 15B is another Raman analysis of a carbon foam made by the Dual Laser process, again showing the presence of a D peak; the 2D peak is lower than the G peak; the peak D: peak G ratio is above zero. FIG. 15C is a Raman analysis of carbon nano-onion material, see ‘Raman spectroscopy of polyhedral carbon nano-onions’. DOI: 10.1007/s00339-015-9315-9, and the similarities with the Raman for the carbon foam made by the Dual Laser process is apparent. One reasonable interpretation is that the carbon foam made by the Dual Laser process is or includes carbon nano-onion material.

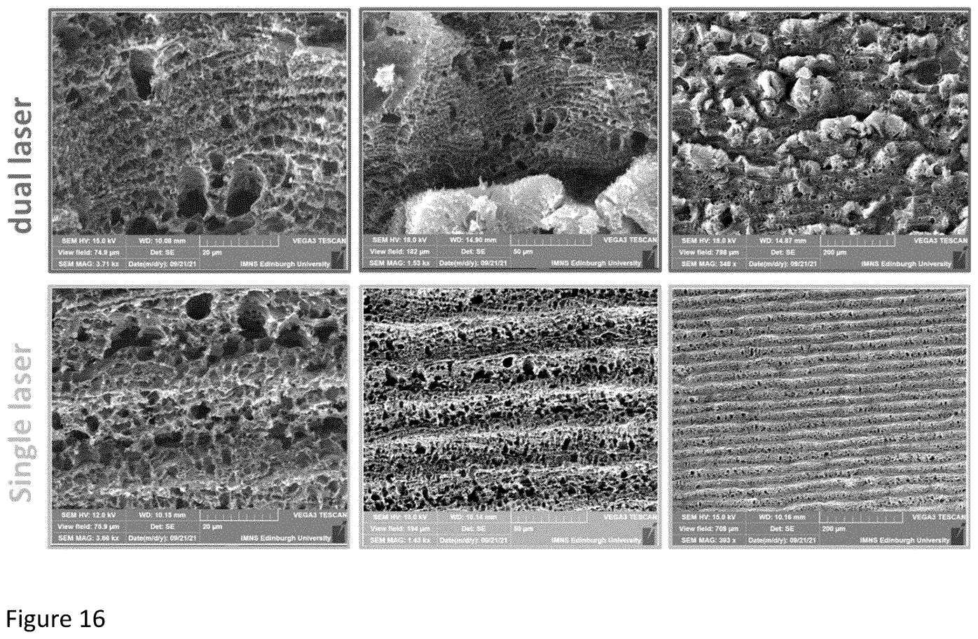

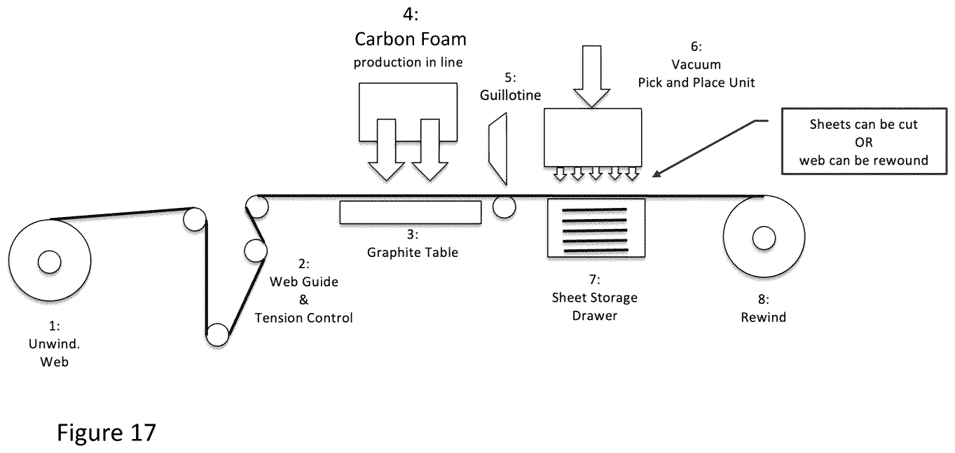

Both the Dual Laser carbon foam and a conventional graphene made by a single laser process show a microporous structure, as shown in the FIG. 16 SEM images. Low magnification images show distinct differences in the surface morphology. The single laser surface shows a smoother, striated surface with rough edges and the carbon foam made by the Dual Laser process shows a rough surface.

### Section B: Key Features of the Carbon Foam Manufacturing Process

In this section, we outline key Features A-L of an implementation of this invention. These features define the production of carbon foam in the Dual Laser manufacturing process described earlier; this process has many advantages over conventional CVD: we can compare the production of 1 cm2 of approximately 50 μm thick carbon foam onto a plastic substrate (or indeed many other types of substrates) in Table 2:

TABLE 2

| | Number of | | | | |
|---|---|---|---|---|---|
| Process | Steps | Time | Temp | Pressure | Cost |
| CVD | 6 | 300 mins | 800 C. | Vacuum | $50 |
| Dual Laser | 1 | 2 mins | 20 C. | Ambient | sub $1 |
| Process | | | | | |

Features A-L define various aspects of a carbon foam manufacturing process that is highly scalable, high yield, highly reproducible and that can be easily adapted to many different applications that all use the same process. For example, the Dual Laser carbon foam is especially well suited to biosensors and electrochemical capacitors (e.g. supercapacitor and pseudo-capacitor applications).

The Dual Laser carbon foam has the following advantages over conventional graphene foam: larger surface area; more porous structure; higher quality; lower sheet resistance; higher wettability; higher anti-fouling.

The Features A-L are organised into the following four groups:

Group 1: Sub-surface carbon foam
Group 2: Dual laser processing

### Group 3: Miscellaneous

We can expand on this organisation as follows:

### Group 1: Sub-Surface Carbon Foam

Feature A: Carbon foam created in a sub-surface region of a carbon pre-cursor material
Feature B: Carbon foam created in an encapsulated region of a carbon pre-cursor material
Feature C: Carbon foam created in a region of a carbon pre-cursor material, where the region has no substantial gas escape pathways
Feature D: Amorphous, non-graphene material adhering to the substrate

### Group 2: Dual Laser Processing

Feature E: Carbon foam created by laser ablating a sub-surface carbon foam region
Feature F: Non-graphene carbon foam created by laser ablating a sub-surface carbon foam region
Feature G: Dual lasers operating at different frequency bands
Feature H: Electrical contacts positioned in carbon foam created by laser ablating a sub-surface carbon foam region
Feature I: Printing electrical contacts on the polyimide film and then creating the exposed carbon foam
Feature J: Tall tracks made in the carbon foam
Feature K: Applying the first and second lasers in different manufacturing facilities

### Group 3: Miscellaneous

Feature L: Scalable manufacturing of carbon foam: Gii 3

### Turning now to Group 1:

### Group 1: Sub-Surface Carbon Foam

### Feature A: Carbon Foam Created in a Sub-Surface Region of a Carbon Pre-Cursor Material

Earlier, prior art approaches to laser induced graphene convert a surface layer of a carbon pre-cursor to 3D graphene. The resultant 3D graphene can however be somewhat brittle, may flake off from the underlying substrate and be generally unsuited to many real-world applications; further, the 3D graphene is typically relatively thin, with a depth of less than 50 μm.

In this specification, we describe an alternative approach in which the surface of the carbon pre-cursor is not converted to graphene at all; instead, it is only a sub-surface region of the carbon pre-cursor 140 that is converted to a carbon foam 160 by a focused laser beam 120; in one implementation, a focused IR beam 120 generates a temperature higher than 500° C. at the sub-surface or encapsulated region inside a polyimide film 140 over a very short time, between 1 ns and 10 μs (i.e. at a rate of between around 5×10⁷° C./s and 2×10¹²° C./s); this brief, intense heating is sufficient to form carbon foam 160 in this sub-surface or encapsulated region. There are no substantial gas escape paths from this sub-surface or encapsulated region 160; constraining the gaseous products to within the sub-surface or encapsulated region beneficially affects the structure of the carbon foam 160 formed in that sub-surface region. Formation of carbon foam 160 solely in a sub-surface region was an unexpected discovery; it was unexpected for several reasons, including a very low absorbance (absorbance of radiation per cm (base 10) of sub 50 or as low as sub 10 of the 1064 nm IR radiation by the polyimide carbon pre-cursor material.

The surface (e.g., the interface between the carbon pre-cursor material perpendicular and facing towards the laser and the gaseous environment surrounding the carbon pre-cursor material) expands under laser irradiation and is converted from the carbon pre-cursor material to a disorganised, amorphous, non-graphene substance 180. This disorganised, amorphous, non-graphene substance 180 forms a layer that is typically at least 1% of the total thickness of the carbon pre-cursor material; for a 500 μm thick polyimide film, then typically the top 1 μm-10 μm is converted to the disorganised, amorphous, non-graphene substance 180; below this upper surface layer, in the body of the carbon pre-cursor material, we have the region that is converted to a carbon foam 160.

The thickness of this carbon foam 160 is controlled by moving the focus of the laser beam progressively through the carbon pre-cursor material; unusually thick carbon foams structures can be made using this process: 50 μm-200 μm (approx.) thick carbon foam tracks have been achieved.

If the laser illuminates a carbon film pre-cursor material, such as a polyimide film that is suspended in space as shown in FIGS. 9-14B (i.e., is not mounted on a substrate), then, after irradiation, as we progressively move through the material, we have at the upper surface, i.e., facing the laser, a disorganised, amorphous, non-graphene substance 180; we then have the carbon foam region 160. The laser beam 120 does not generally approach the lower surface of the carbon pre-cursor material, so that the carbon foam region 160 sits over carbon pre-cursor material that has not been converted to a carbon foam. If the laser approaches the lower surface of the carbon pre-cursor material, then the carbon pre-cursor close to and at the lower surface is converted to a disorganised, amorphous, non-graphene substance.

Similarly, if the laser illuminates a carbon pre-cursor film, such as a polyimide (PI) film that is mounted on a substrate, as shown in FIGS. 1-6, then we have the same sequence of materials; in addition, the laser will usually approach the lower surface of the carbon pre-cursor material that lies against the substrate: the carbon pre-cursor close to and at the lower surface is then converted to a disorganised, amorphous, non-graphene substance 170. This disorganised, amorphous, non-graphene substance 170 adheres to the substrate 150; since the carbon foam region 160 is bonded to this disorganised, amorphous, non-graphene substance 170, the result is that the carbon foam region 160 is itself not bonded directly to the substrate 150, but is nevertheless securely attached via the intermediary disorganised, amorphous, non-graphene substance 170 to the substrate 150.

This approach enables carbon foam structures that are significantly thicker than is possible with earlier approaches that limited graphene foam formation to a surface region. Further, this approach enables carbon foam structures that adhere more robustly, although not directly, to an underlying substrate. Note that with this approach, carbon foam is not produced at any surface of the carbon pre-cursor material. Instead, carbon foam is produced solely in a sub-surface region inside the carbon pre-cursor material.

We can generalise to:

A method of manufacturing carbon foam material comprising the step of irradiating a sub-surface region of a carbon pre-cursor material, parameters of the laser beam being selected to create a carbon foam in that sub-surface region.

### Feature B: Carbon Foam Created in an Encapsulated Region of a Carbon Pre-Cursor Material

In Feature A above, we defined the region in which the carbon foam is generated by laser irradiation as a ‘sub-surface’ region. Another way of describing the region is to qualify it as ‘encapsulated’; this captures the 3-dimensional relationship of the carbon foam to its surroundings; the carbon foam 160 is ‘encapsulated’ by the original carbon precursor material and by the disorganised, amorphous, non-graphene substance 180 generated by laser irradiation at the upper surface of the carbon pre-cursor material 140.

We can generalise to:

A method of manufacturing carbon foam material comprising the step of irradiating an encapsulated region of a carbon pre-cursor material, parameters of the laser beam being selected to create a carbon foam in that encapsulated region.

Feature C: Carbon Foam Created in a Region of a Carbon Pre-Cursor Material, where the Region has No Substantial Gas Escape Pathways

We have seen above that a sub-surface or encapsulated region of the carbon pre-cursor is converted to a carbon foam and there are no substantial gas escape paths from this sub-surface or encapsulated region; constraining the gaseous products to within the sub-surface or encapsulated region affects the structure of the carbon foam 160 formed in that region.

We can generalise to:

A method of manufacturing carbon foam material comprising the step of irradiating an encapsulated, sub-surface region of a carbon pre-cursor material, parameters of the laser beam being selected to create a carbon foam in that region and in which no substantial gas escape pathways to a surface of the pre-cursor material are created by the laser beam.

### Feature D: Amorphous, Non-Graphene Material Adhering to the Substrate

We have seen earlier that if the laser 110 illuminates a carbon film 140 that is mounted on a substrate 150, then the laser carbonises the surface of the carbon film adjacent to the substrate 150 to form a disorganised, amorphous, non-graphene substance 170 adjacent to the substrate 150; this disorganised, amorphous, non-graphene substance 170 adheres to the substrate 150; since the internal, or sub-surface or encapsulated carbon foam region 160 is itself bonded to this disorganised, amorphous, non-graphene substance 170, the result is that the carbon foam region 160 is itself not directly attached to the substrate 150, but is nevertheless securely positioned on the substrate 150, via the intermediary disorganised, amorphous, non-graphene substance 170. The carbon foam region 160 is more securely bonded, compared to conventional laser induced graphene, and is less likely to flake off, even where the substrate is flexible, enabling for example biosensor applications where the substrate is often a thin and flexible structure.

We can generalise to:

A method of manufacturing carbon foam material comprising the step of irradiating an internal region of a carbon pre-cursor material, positioned on a substrate, parameters of the laser beam being selected to create a carbon foam in that region and to create a disorganised, amorphous, non-graphene material between the carbon foam region and the substrate; in which that disorganised, amorphous, non-graphene material is adhering or otherwise attaching directly to the substrate.

### Group 2: Dual Laser Processing

### Feature E: Carbon Foam Created by Laser Ablating a Sub-Surface Carbon Foam Region

Previous Features A-D have covered the creation of a carbon foam in a sub-surface or encapsulated region of the carbon pre-cursor material. Because the carbon foam is not formed on an exposed surface, and many applications require the carbon foam to be exposed, we can perform an additional step to expose at least some of the sub-surface or encapsulated carbon foam.

We have seen earlier that the laser irradiation using IR laser 110 forms a disorganised, amorphous, non-graphene material 180 over the sub-surface or encapsulated carbon foam 160: We now use a laser, typically a long IR CO2 laser 125, to ablate or otherwise treat this disorganised, amorphous, non-graphene material 180 and hence expose the underlying carbon foam 160. This second laser 125 is typically de-focused, unlike the initial laser.

As noted earlier, we use a standard 220 mm×180 mm polyimide sheet (but other sizes of polyimide sheet can be accommodated); this size that can be accommodated in a standard laser scanning device, of the sort typically used for laser engraving, laser cutting and laser plotting that traces out a path defined by a standard CAD program, and also a standard flatbed screen printing device, and a standard conveyor dryer. Other sizes of polyimide sheet can be accommodated.

We have found that this secondary laser irradiation step alters the morphology and other characteristics of the underlying carbon foam in surprising and favourable ways, to generate a twisted or turbostratic multilayer carbon foam not previously observed. Varying the CO₂ laser 125 parameters can alter the carbon foam material properties, enabling carbon foam to be produced with properties that are optimised for different applications.

This newly exposed carbon foam includes one or more of the following properties:
a readily controlled thickness or depth
greater flexibility compared to the highly brittle graphene made using conventional laser processes.
strong adhesion to any underlying flexible substrate
high porosity
high electrical conductivity
increased capacitance or charge storage
rapid absorption of organic solvents and water-based solutions
higher hydrophilicity
high EMI shielding
enhanced electrode quality
high wettability
anti-fouling

Note that it is possible to alter one or more of these properties, as well as the size and extent of defects, and the size (including the relative size) of the Raman D and 2D peaks, by varying the laser parameters of either or both of the laser used in the Dual Laser process. In this way, it is possible to produce a carbon foam with properties tuned or especially suitable for different applications. It was surprising that the operation of the second ablation laser could enable the creation of a useable, exposed carbon foam region, especially one with properties that could be adjusted by varying the parameters of the first and/or second lasers.

We can generalise to:

A method of manufacturing carbon foam material comprising the steps of (a) a laser beam irradiating an encapsulated or sub-surface region of a carbon pre-cursor material, to create a carbon foam in that encapsulated or sub-surface region and a disorganised, amorphous non-graphene substance above the carbon foam, and then (b) laser ablation or treatment to remove the disorganised, amorphous non-graphene substance and to expose at least some of the carbon foam.

### Feature F: Carbon Foam Created by Laser Ablating a Sub-Surface Carbon Foam Region

In the preceding Feature E, we described the formation of carbon foam 160 in an encapsulated or sub-surface region of the carbon pre-cursor by irradiating that region with a laser 110 (e.g. an IR laser); that irradiation causes the overlying (in the direction of the laser) carbon pre-cursor material 140 to expand into a disorganised, amorphous, non-graphene substance 180; we then expose or reveal that carbon foam 160 by ablating the overlying disorganised, amorphous, non-graphene substance 180 with a second laser 125, e.g. a CO2 laser. This second irradiation step not only ablates the overlying disorganised, amorphous non-graphene substance 180 and hence exposes the underlying carbon foam 160, but also gives this underlying carbon foam an unexpected and unusual surface morphology 185 with very desirable characteristics; this resultant carbon foam may be a twisted or turbostratic, multilayer carbon foam.

However, because this foam may have characteristics (such as extensive defects, appearance, wettability and a Raman spectrum which are not associated with a graphene foam, in this Feature F, we explicitly describe this foam as a ‘non-graphene carbon foam’. The term ‘non-graphene carbon foam’ hence (unlike the term ‘carbon foam’) explicitly excludes graphene foams, including twisted or turbostratic multilayer graphene foams, but extends to cover any other 3D carbon material foam.

We can generalise to:

A method of manufacturing non-graphene carbon foam comprising the steps of
(a) a laser beam irradiating an encapsulated or sub-surface region of a carbon pre-cursor material to create a carbon foam in that encapsulated or sub-surface region in the carbon pre-cursor material, and a disorganised, amorphous non-graphene substance above the carbon foam and then
(b) laser ablation or treatment to remove the disorganised, amorphous non-graphene substance and expose at least some of the underlying carbon foam and transform at least some of that underlying carbon foam into a non-graphene carbon foam.

### Feature G: Dual Lasers at Different Bands

We have seen in the preceding Features E and F that we may use two separate laser irradiation steps. These are usually carried out using two separate lasers: the first step, that creates the sub-surface or encapsulated carbon foam, is typically done with a focused IR laser 110; and the second step involves laser irradiation at a longer wavelength with a de-focused CO2 laser 125, but other wavelengths (e.g., UV and visible) may also be used.

The second laser 125 ablates the material 180 sitting between the carbon foam 160 and the surface (e.g., a disorganised, amorphous non-graphene material) and exposes the underlying carbon foam 160. The exposed carbon foam 160 may also be altered (e.g., in its surface morphology 185) by the second laser, i.e. the term ‘exposes’ should be construed broadly to include not just revealing at least some of the pre-existing carbon foam, but also transforming or altering at least some of the pre-existing carbon foam into a 3D carbon material foam with characteristics that differ from those of the pre-existing graphene foam.

We can generalise to:

A method of manufacturing a carbon foam material comprising the steps of
(a) using a laser beam operating at a first band to irradiate an encapsulated or sub-surface region of a carbon pre-cursor material below a surface of the material, to create carbon foam in that encapsulated or sub-surface region, and then
(b) using a laser beam operating at a second band to remove or ablate material sitting above the carbon foam, to expose at least some of the carbon foam.

### Feature H: Electrical Contacts Positioned in Carbon Foam Created by Laser Ablating a Sub-Surface Carbon Foam Region

We have seen earlier how we create a carbon foam, which may be a twisted or turbostratic, multilayer carbon foam: because this material has exceptional electrical properties (e.g., conductivity; capacitance), we can attach or locate one or more electrical contacts (including also electrical items such as flexible electronics, microprocessors, antennas, IoT devices, electrical interfaces) into the carbon foam. For printed tracks (e.g. screen printed silver tracks), these are screen printed onto the polyimide film (or other suitable substrate) and over and into the pre-existing 3D carbon material foam, so that the tracks make good electrical contact with the foam, and any structures formed on the foam.

We can generalise to:

A method of manufacturing carbon foam material comprising the steps of:
(a) using a laser beam operating at a first band to irradiate an encapsulated or sub-surface region of a carbon pre-cursor material below a surface of the material, to create carbon foam in that encapsulated or sub-surface region, and then
(b) using a laser beam operating at a second band to remove or ablate material sitting above the carbon foam, to expose at least some of the carbon foam; and
(c) attaching, printing or locating one or more electrical contacts into the carbon foam.
   Feature I: Printing Electrical Contacts on the Polyimide Film and then Creating the Exposed Carbon Foam

In Feature H, we have seen that once the Dual Laser process is completed, then electrical contacts or circuits are added to contact the pre-existing carbon foam—e.g. simple silver electrical contacts can be screen printed on to the carbon foam. In this Feature I, we describe starting the process by first screen printing the electrical contacts on to the polyimide film, and then finishing the process by creating the exposed carbon foam using the second, laser ablation step of the Dual Laser process. This has some advantages, because the screen printing process can disturb or disrupt the carbon foam. This is a process we call ‘PPC’, an acronym for Post Printing Conversion, in which the screen printing steps are done before the Dual Laser process to create the carbon foam.

So for screen printed tracks (e.g. screen printed silver tracks), these are screen printed onto the polyimide film (or other suitable substrate) in such a way that the carbon foam is subsequently formed around one end of the printed tracks, providing a contact area with a large surface and hence very good electrical connectivity. As with the alternative process described in Feature H above, the printed tracks also make good electrical contact with any structures formed on the foam.

An alternative sequence involves using the first laser beam to create the sub-surface carbon foam, then screen printing the electrical contacts, and then using the second laser beam to create the carbon foam in a way that makes good electrical contact with the electrical contacts.

We can generalise to:

A method of manufacturing carbon foam material comprising the steps of:
(a) screen printing electrical contacts onto or into a carbon pre-cursor material;
(b) using a laser beam operating at a first band to irradiate an encapsulated or sub-surface region of a carbon pre-cursor material below a surface of the material, to create carbon foam in that encapsulated or sub-surface region, and where steps (a) and (b) can be performed in the sequence (a) then (b) or (b) then (a); and
(c) using a laser beam operating at a second band to remove or ablate material sitting above the carbon foam, to expose at least some of the carbon foam to which the electrical contacts are connected.

### Feature J: Tall Tracks Made in the Carbon Foam

We have seen earlier that the thickness of the sub-surface or encapsulated carbon foam region can far exceed the thickness of conventional graphene foams that are restricted to a surface layer: the laser focus of the first laser beam can be progressively moved down through the carbon pre-cursor material to create a deep or thick layer of sub-surface or encapsulated carbon foam. We then deploy the second laser irradiation step, ablating the material sitting between the carbon foam and the surface of the carbon pre-cursor material, resulting in an exposed region of carbon foam. The thickness or depth of this now-exposed carbon foam region can be at least 50 μm; carbon foam of 300 μm thickness has been produced. Increased thickness is beneficial because it can result in better electrical conductivity, greater capacitance, and greater mechanical integrity.

We can generalise to:

A method of manufacturing carbon foam material comprising the steps:
(a) using a laser beam operating at a first band to irradiate an encapsulated or sub-surface region of a carbon pre-cursor material below a surface of the material, to create carbon foam in that encapsulated or sub-surface region, and then
(b) using a laser beam operating at a second band to remove or ablate material sitting above the carbon foam, to expose at least some of the carbon foam;
and where the carbon foam is at least 50 μm in thickness or depth.

### Feature K: Applying the First and Second Lasers in Different Manufacturing Facilities

The specific properties or structure of the carbon foam that results from the second laser may be considered to be sensitive information because they define features of the final product; it may well be desirable for the first laser beam process to be carried out by a supplier of the carbon foam at that supplier's manufacturing facility, who then supplies that carbon foam to a customer, who in turn carries out the final stage, using the second laser beam, at their own manufacturing facility As we noted earlier, by varying the parameters of the first and also the second laser, it is possible to alter the carbon foam material properties, enabling carbon foam to be produced with properties that are optimised for different applications. Typical parameters that can be altered or tuned in this way include: intensity, wavelength, pulse frequency, pulse duration, pulse profile, scanning speed, focal distance, heat generated at the sub-surface or encapsulated region.

By splitting the manufacturing process in this way, the supplier is insulated from knowledge of the specific manufacturing processes used by a customer as part of the second laser, ablation process (e.g. how they vary the parameters of the second laser beam to give the exposed carbon foam the properties they require); the customer can keep the details of how they produce finished products confidential.

So the manufacturing process is a three-stage process involving the steps: (a) the first laser beam irradiating a sub-surface region of a carbon pre-cursor material at a manufacturing site to produce unfinished carbon foam product; (b) the unfinished carbon foam product being transferred to a customer-controlled manufacturing site; and (c) the laser ablation or treatment taking place at the customer-controlled manufacturing site.

In addition, this approach enables large scale manufacturing (e.g. see Feature L) of the carbon foam produced by just the first laser process, reducing the cost of this material, which can be used across a number of different applications and customers. The more specialised products generated using the second laser beam may well be manufactured at much lower quantities than the carbon foam produced by just the first laser process. So this approach enables more efficient and lower cost manufacturing of the base material, i.e. the carbon foam produced by just the first laser process.

We can generalise to:

A method of manufacturing a device comprising the steps:
(a) using a laser beam operating at a first band to irradiate an encapsulated or sub-surface region of a carbon pre-cursor material below a surface of the material, to create carbon foam in that encapsulated or sub-surface region, and then
(b) using a laser beam operating at a second band to remove or ablate material sitting above the carbon foam, to expose at least some of the carbon foam;
in which step (a) is performed at one manufacturing facility and step (b) is performed at a different facility.

### Group 3

### Feature L: Scalable High Speed Manufacturing: G-ii 3

Gii-3 is a scalable manufacturing plant with reel-to-reel or reel-to-sheet production of all of the Gii-based materials described above. A key commercially advantage is that Gii 3 manufacturing does not need bespoke equipment—it uses off the shelf computer controlled lasers for the Dual Laser carbon foam manufacturing and conventional screen printing and drying technology: these are well known, well understood manufacturing processing steps and equipment, leading to repeatability and reliability.

We can generalise to:

A method of manufacturing a device including carbon foam material;
in which the method includes passing a continuous reel of a carbon pre-cursor film through a sequence of operations required to manufacture the carbon foam material made, at least in part, by the method defined in any of Features A-K above.

For Features A-L, the following optional features are especially relevant. Note that any one or more of the following optional features may each be combined with any one or more other, compatible optional features and with any one or more of Features A-L:

We will cover the following areas:
the manufacturing processes
the first laser beam parameters and control scheme
attributes of the sub-surface or encapsulated region
the carbon pre-cursor material
the substrate supporting the carbon pre-cursor material
the carbonisation at the surface that the laser beam is incident on
the ablation laser beam or second laser beam
the carbon foam

Note that any one or more of the following optional features may each be combined with any one or more other, compatible optional features and with any one or more of the other ‘Features’ listed in this specification (e.g., Features A-L).

The laser-based manufacturing process described above has many advantages over a conventional CVD process; we can list these as the following optional features:
is a room temperature process.
is an ambient pressure process.
can be performed on a plastic substrate (compatible with any manufacturing process, not just silicon chip fabrication).
can be done without a catalyst.
takes approximately 2 minutes or less to manufacture 1 cm2 of approximately 50 μm thick carbon foam onto a plastic substrate.
enables a 3D carbon foam to be created on a flexible substrate
requires no graphene or graphene oxide precursor.
creates carbon foam material solely in the encapsulated or sub-surface region of the carbon pre-cursor material and not at any surface of the carbon pre-cursor material.
uses a combination of industry standard, low cost and scalable (i) screen printing technology and (ii) computer-controlled laser scanning technology.
can be adapted for high-speed, high volume reel-to-reel or reel-to-sheet production.

The first laser beam parameters and control scheme are important to the production of carbon foam; we define the relevant optional features here:
parameters of the laser beam that irradiates the sub-surface or encapsulated region include one or more of: intensity, wavelength, pulse frequency, pulse duration, pulse profile, scanning speed, focal distance, heat generated at the sub-surface or encapsulated region.
varying the laser parameters alters the carbon foam material properties, enabling carbon foam to be produced with properties that are optimised for different applications.
varying the laser parameters alters one or more of the following carbon foam material properties or parameters: size of defects, distribution of defects, extent of defects, type of defects, of the Raman D and 2D peaks, relative size of the Raman D and 2D peaks, thickness or depth, flexibility, adhesion, porosity, electrical conductivity, capacitance, absorption of organic solvents and water-based solutions, hydrophilicity, EMI shielding, electrode quality, wettability, contact angle, anti-fouling.
laser beam generates a temperature higher than 500° C. in the sub-surface or encapsulated region to form carbon foam.
laser beam generates a temperature of over approximately 500° C. in the sub-surface or encapsulated region to form carbon foam.
laser pulse duration is between approximately 1 ns and 10 μs, giving a heating rate of between around 5×10⁷° C./s and 2×10¹²° C./s.
laser power is within a typical working range of 8-20 watts, with 12 W optimum.
laser focal distance is within a typical working range of 50 mm-400 mm.
laser pulse frequency is between approximately 50 kHz and 500 kHz.
laser pulse frequency is between approximately 1 kHz and 2 MHz.
laser wavelength is between approximately 0.7 μm-2.5 μm.
laser is scanned at between approximately 9 cm/s and 40 cm/s.
parameters of the laser beam include focus parameters.
parameters of the laser beam include diffraction parameters.
parameters of the laser beam include interference pattern parameters.
focus of the laser beam moves through the depth of the carbon pre-cursor material to generate carbon foam in the sub-surface or encapsulated region of the carbon pre-cursor that the focus passes through.
focus of the laser beam moves at least approximately 50 μm through the depth of the carbon pre-cursor material to generate carbon foam in the sub-surface or encapsulated region of the carbon pre-cursor of at least 50 μm thickness
focus of the laser beam moves at least approximately 100 μm through the depth of the carbon pre-cursor material to generate carbon foam in the sub-surface or encapsulated region of the carbon pre-cursor of at least 100 μm thickness.
laser beam scans (e.g., raster scans) or moves laterally across the carbon pre-cursor material to form a desired pattern.
laser beam scans or moves laterally across the carbon pre-cursor material to form a desired pattern that includes non-overlapping regions or lines.
laser beam is repeatedly scanned (e.g., raster scanned) or moved laterally across the carbon pre-cursor material with a focus or intensity maximum arranged to multiple different depths within the carbon pre-cursor material until carbon foam of the required pattern and depth has been created.
laser beam is scanned at a scan rate of between 1.7 mm/s and 3550 m/s, or more typically between 35 mm/s and 350 mm/s and the scanning may be such that the number of pulses per inch (PPI) is between 100 and 10000 (relevant to the production of individual approximately polyimide sheets of size 220 mm×180 mm).
laser beam has a wavelength with substantially no absorbance by the carbon pre-cursor material.
laser beam has a wavelength with very low absorbance by the carbon pre-cursor material, where the radiation absorbance per cm (base 10) is below 50, or below 20 or below 10.
laser beam is an IR laser.
laser beam is an IR laser with wavelength of between approximately 0.7 μm-2.5 μm.
laser beam is an IR laser with wavelength of between approximately 0.75 μm-1.40 μm.

The attributes of the sub-surface or encapsulated region in which carbon foam is created can be defined by the following optional features:
unlike conventional graphene foams, the sub-surface or encapsulated region can be over approximately 50 μm in thickness.
a desired depth of the sub-surface or encapsulated region in the carbon pre-cursor material is achieved by moving the focus of the first laser beam through that depth.
the sub-surface or encapsulated region can be at different depths below the surface of the carbon pre-cursor material facing the incident laser; the exact depth at which the sub-surface or encapsulated region is a function of various factors, such as laser intensity, the choice of carbon pre-cursor material used etc. For example, the sub-surface or encapsulated region can be at least approximately 10 μm, 20 μm, 30 μm, 40 μm, 50 μm or more below the surface of the carbon pre-cursor material.
the sub-surface or encapsulated region can have a thickness of between approximately 10 μm and 200 μm.
the sub-surface or encapsulated region is at a distance below the surface of the carbon pre-cursor material that is a function of various factors, such as laser intensity, other laser parameters, the choice of carbon pre-cursor material used etc. For example, the top of the sub-surface or encapsulated region can be below the surface by at least 1%, 10%, 20%, 30%, 40% of the total thickness of the carbon pre-cursor material.
the sub-surface or encapsulated region is a volume of space centred at the mid-point of the minimum cross-section of the first laser beam and the volume is within 500 or 100 microns, or 1 micron of this mid-point.

The carbon pre-cursor material can be defined by the following optional features:
the carbon pre-cursor material is made substantially of thermo-setting material.
the carbon pre-cursor material is made substantially of non-thermo-plastic material.
the carbon pre-cursor material is a thermo-setting film.
the thermo-setting film is a polyimide film.
carbon pre-cursor is a polyimide film.
carbon pre-cursor is a polyimide polyimide film, the wavelength of the first laser is within the range of 0.7 μm to 2.5 μm.
carbon pre-cursor is at least 50% carbon by mass, or at least 75% carbon by mass, or at least 90% carbon by mass.
carbon pre-cursor is a film or sheet.
the carbon pre-cursor material is flexible.
the carbon pre-cursor material is a printed layer, such as a screen-printed layer.
the carbon pre-cursor material has a thickness greater than 5 μm, or between 5 μm and 120 μm, or greater than 120 μm.
the carbon pre-cursor material is substantially planar or flat and is oriented perpendicular to the first laser beam.
the carbon pre-cursor material is homogeneous.
the carbon pre-cursor material is heterogenous and comprises several different materials.
carbon pre-cursor is supported on a substrate that is not made of a carbon pre-cursor.
the absorption coefficient of the carbon pre-cursor material at the first laser beam wavelength is low.
the absorption coefficient of the carbon pre-cursor material for the first laser beam is below 50 cm⁻¹, or below 20 cm⁻¹, or below 10 cm⁻¹
the absorption coefficient of the carbon pre-cursor material for the second or ablation laser beam (see Group 3 Features below) is below 300 cm⁻¹
the absorption coefficient of the carbon pre-cursor material for the second or ablation laser beam is 300±50 cm⁻¹
the carbon pre-cursor material has a thermal conductivity of less than 1.0 W/mK (using a method according to ASTM D5470).
the carbon pre-cursor material has a thermal conductivity of less than 0.5 W/mK (using a method according to ASTM D5470).
carbon pre-cursor material is mounted on a substrate that is substantially optically transparent at the wavelength or wavelengths of the first and/or second laser beams.
the carbon pre-cursor material carbon source comprises or is formed from one or more polymers.
the carbon pre-cursor material comprises one or more of the following materials: polyimides (for example, poly(4,4′-oxydiphenylene-pyromellitimide), otherwise known as polyimide), polyetherimides (PEI), poly(methyl methacrylate) (PMMA) (e.g. spray-coated PMMA), polyurethanes (PU), polyesters, vinyl polymers, carbonized polymers, photoresist polymers, alkyds, urea-formaldehyde.
the carbon pre-cursor comprises one or more of the following materials: poly(amic acids) (for example an aryl-containing poly (amic acid)) (for example poly(pyromellitic dianhydride-co-4,4′-oxydianiline), amic acid—otherwise known as polyamic acid); dianhydrides (for example aryl dianhydrides) (for example pyromellitic dianhydride); derivatives of said poly(amic acids); derivatives of said dianhydrides (e.g., derivates of pyromellitic dianhydride).
the carbon pre-cursor comprises one or more of the following materials: aromatic materials (e.g., aromatic polymers); heteroaromatic materials (e.g., heteroaromatic polymers); polymers containing aromatic moieties; cyclic materials (e.g., polymers containing cyclic moieties); heterocyclic materials (e.g., polymers containing heterocyclic moieties); heteroaromatic materials (e.g., polymers containing heteroaromatic moieties).
the carbon pre-cursor comprises material: containing one or more of aromatic bonds, or heteroaromatic bonds or hetero bonds (e.g., imide bonds).

A substrate can be thought of as a material that presents a surface on which the carbon pre-cursor is positioned; the specific materials, thickness and properties of the substrate are determined by the application: for example, for some sensors, the substrate could be a thin flexible plastic membrane; for other applications, the substrate could be a rigid polyimide board on which electronic circuitry can be mounted. The IR laser can irradiate the carbon source directly; alternatively, radiation from the IR laser may first pass through a substrate before reaching the carbon source, in which case there are two alternative scenarios: first, the substrate is substantially transparent to the IR radiation and the mechanism of carbon foam formation is as described above. But in a second scenario, the substrate is substantially non-transparent to the IR radiation: then, rapid thermal transfer from the substrate into the carbon pre-cursor material first produces a disorganised, amorphous non-graphene layer at the interface layer with the substrate, and carbon foam is then formed in a sub-surface or encapsulated region inside the carbon pre-cursor material.

The substrate on which the carbon pre-cursor material may be positioned and supported can be defined by the following optional features:
the substrate is a plastic body, film, or foil.
the substrate is flexible.
the substrate is a polyimide circuit board.
the substrate has very low absorbance of the first laser beam.
the substrate is substantially optically transparent at the wavelength or wavelengths of the first laser beam.
the substrate has a high absorbance of the first laser beam, absorbing greater than 60% of the first laser beam
the substrate has a high absorbance of the first laser beam, absorbing greater than 60% of the first laser beam and has a thermal conductivity of at least 10 W/mK.
the surface of the carbon pre-cursor material is converted to a disorganised, amorphous, non-graphene substance by the laser beam and that disorganised, amorphous, non-graphene substance adheres or bonds to the substrate and hence indirectly attaches the 3D carbon material foam to the substrate.
the substrate is formed from one or more of the following: silicon (Si), silicon dioxide (SiO2), gallium nitride (GaN), gallium arsenide (GaAs), zinc oxide (ZnO).
the substrate is silicon wafer.
the substrate is a silicon dioxide wafer.
the substrate is a wafer comprising both silicon and silicon dioxide.
the substrate is a carbon source.
the substrate is not a carbon source, e.g. is a metal, dielectric material, a screen-printed dielectric material.
the carbon pre-cursor is positioned ‘above’ the substrate (e.g. the carbon pre-cursor is positioned closer to the laser sources than the substrate).
the carbon pre-cursor is positioned ‘below’ the substrate (e.g. the carbon pre-cursor is positioned further from the laser sources than the substrate).

The carbonisation at the surface that the laser beam is incident on can be defined by the following optional features:
the surface of the carbon pre-cursor material is converted to a disorganised, amorphous, non-graphene substance by the first laser beam.
the disorganised, amorphous, non-graphene substance occupies a thickness below the surface of the adjacent carbon pre-cursor material that is approximately 1%, or less than approximately 1%, or less than approximately 5%, or less than approximately 10%, of the total thickness of the carbon pre-cursor material.
the disorganised, amorphous, non-graphene substance extends to a distance below the surface of the carbon pre-cursor material that is at least 10 μm.
the disorganised, amorphous, non-graphene substance extends from the outer surface into the body of the carbon pre-cursor material to a depth of 10 μm or less, or to a depth of 20 μm or less, or to a depth of 30 μm or less, or to a depth of 40 μm or less, or to a depth of 50 μm or less, or to a depth of 100 μm or less.

The ablation laser beam or second laser beam can be defined by the following optional features:
parameters of the laser beam include one or more of: intensity, wavelength, pulse duration, pulse profile, scanning speed, heat generated at the sub-surface or encapsulated region.
varying the laser parameters alters the carbon foam material properties, enabling carbon foam to be produced with properties that are optimised for different applications.
varying the laser parameters alters one or more of the following carbon foam material properties or parameters: type of carbon nanostructures present (e.g. carbon nano-onion etc), size of defects, distribution of defects, extent of defects, type of defects, of the Raman D and 2D peaks, relative size of the Raman D and 2D peaks, thickness or depth, flexibility, adhesion, porosity, electrical conductivity, capacitance, absorption of organic solvents and water-based solutions, hydrophilicity, EMI shielding, electrode quality, wettability, contact angle, anti-fouling.
laser beam that ablates the amorphous, non-graphene substance that is formed above the encapsulated or sub-surface region in the carbon pre-cursor (the ‘second laser beam’) is a CO2 laser.
the second laser beam alters the carbon foam as part of the process of exposing it.
the second laser beam alters the morphology of the carbon foam as part of the process of exposing it.
The second laser beam is automatically controlled to be scanned (e.g., raster scanned) across the same regions, and/or overlapping regions and/or non-overlapping regions.
wavelength of the laser beam that ablates the amorphous, non-graphene substance is between 8 μm-15 μm.
the second laser beam is a long IR laser, or a UV laser or a visible light laser.
the second laser beam has a pulse frequency of between 50 kHz and 500 kHz and a scan speed of between 9 cm/s and 40 cm/s.
the absorption coefficient of the carbon pre-cursor material is above 100 cm⁻¹ for the second laser beam, or above 200 cm⁻¹ for the second laser beam.
the absorption coefficient of the carbon pre-cursor material is 300±50 cm⁻¹ for the second laser beam.
laser power is within a typical working range of 8-20 watts, with 12 W optimum.
laser focal distance is within a typical working range of 50 mm-400 mm.
the second laser beam is scanned in a pattern that includes non-overlapping regions or lines.
the second laser beam is scanned in a pattern that matches the scan pattern of the first laser beam.
the second laser beam is de-focused.
the manufacturing process is a three-stage process involving the steps: (a) the first laser beam irradiating a sub-surface region of a carbon pre-cursor material at a manufacturing site to produce unfinished carbon foam product; (b) the unfinished carbon foam product being transferred to a customer-controlled manufacturing site; and (c) the laser ablation or treatment taking place at the customer-controlled manufacturing site.

The carbon foam can be defined by the following optional features:
the carbon foam is at least 50 μm in thickness.
the carbon foam is between 50 μm to 300 μm in thickness.
the carbon foam is or includes a twisted or turbostratic multilayer foam.
the carbon foam is or includes a carbon foam with a spatial distribution of defects leading to high electrochemical reactivity.
the carbon foam is or includes a carbon foam with vacancy position basal plane defects leading to high electrochemical reactivity.
the carbon foam has a Carbon: Oxygen ratio of between 25:1 and 50:1.
the carbon foam has a fast electron transfer constant.
the carbon foam has one or more of the following properties
   a readily controlled thickness or depth
   greater flexibility compared to the highly brittle graphene made using conventional laser processes.
   strong adhesion to an underlying flexible substrate
   high porosity
   high electrical conductivity
   increased capacitance or charge storage
   rapid absorption of organic solvents and water-based solutions
   higher hydrophilicity
   high EMI shielding
   enhanced electrode quality
   a contact angle of approximately 20° or less
the properties of the carbon foam are selected by choosing specific laser parameters to generate carbon foam material with one or more of the following desired properties or parameters: size of defects, distribution of defects, extent of defects, type of defects, of the Raman D and 2D peaks, relative size of the Raman D and 2D peaks, thickness or depth, flexibility, adhesion, porosity, electrical conductivity, capacitance, absorption of organic solvents and water-based solutions, hydrophilicity, EMI shielding, electrode quality, wettability, contact angle, anti-fouling.

### Non-Graphene Carbon Material Foam

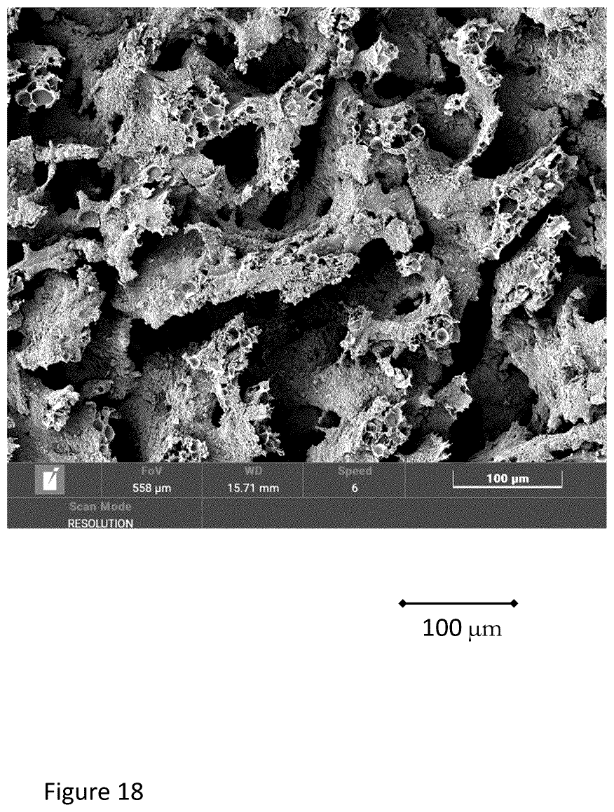

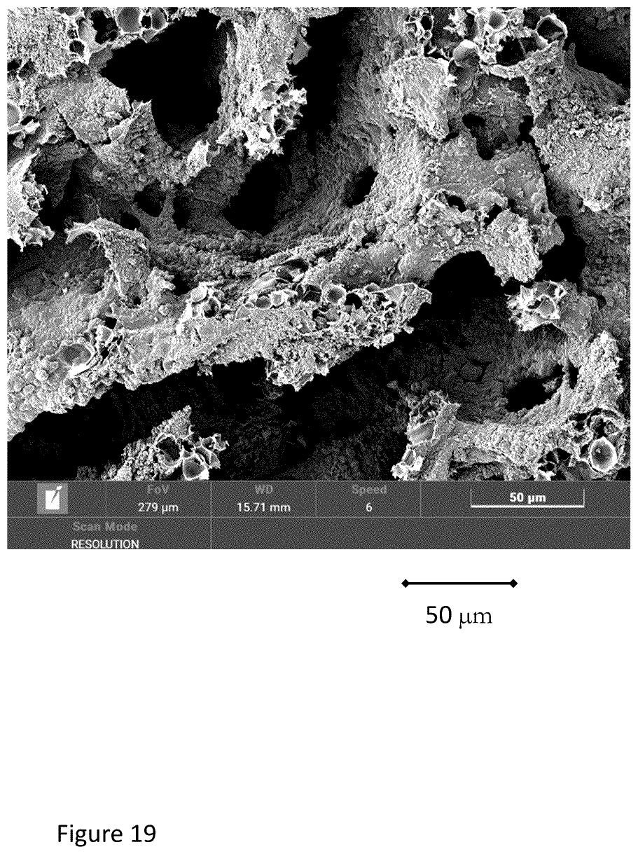

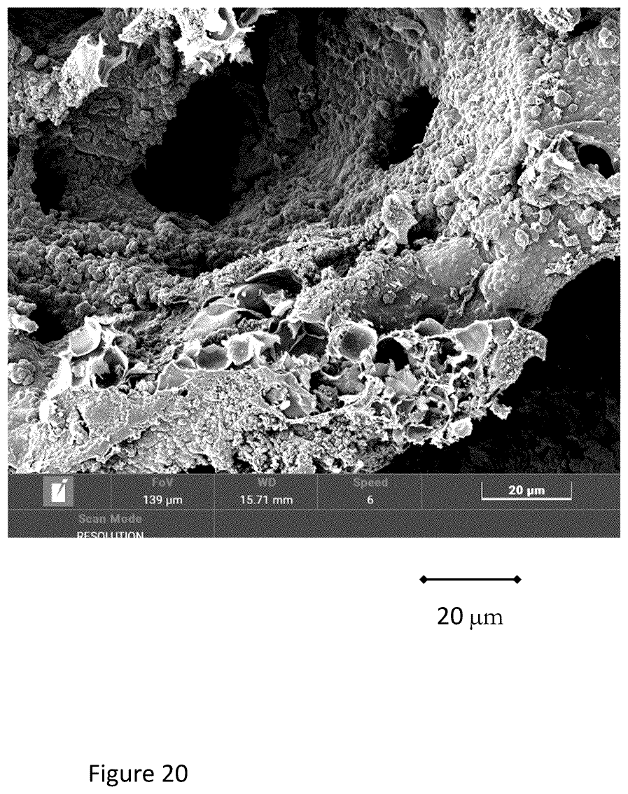

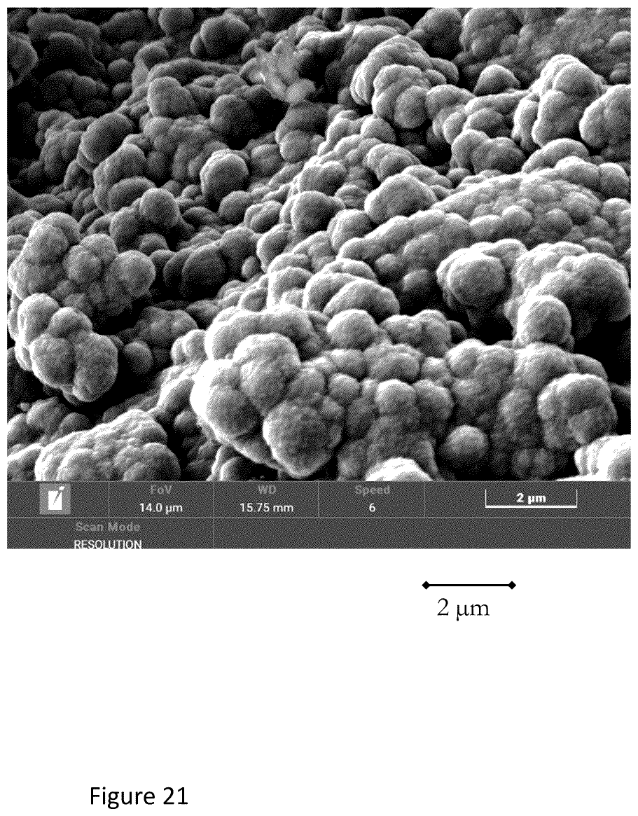

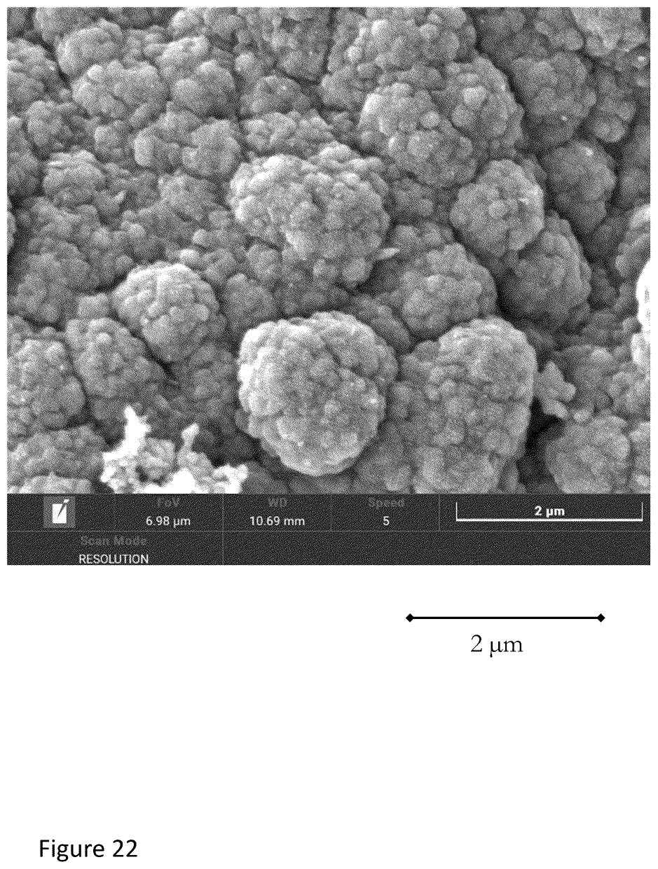

Conventional graphene foam appears, under a scanning electron microscope, to have large, open ring-like structures, typically 500 μm in size. The carbon foam generated using the Dual Laser process looks very different; FIGS. 18-22 are SEM images of this Gii carbon foam.

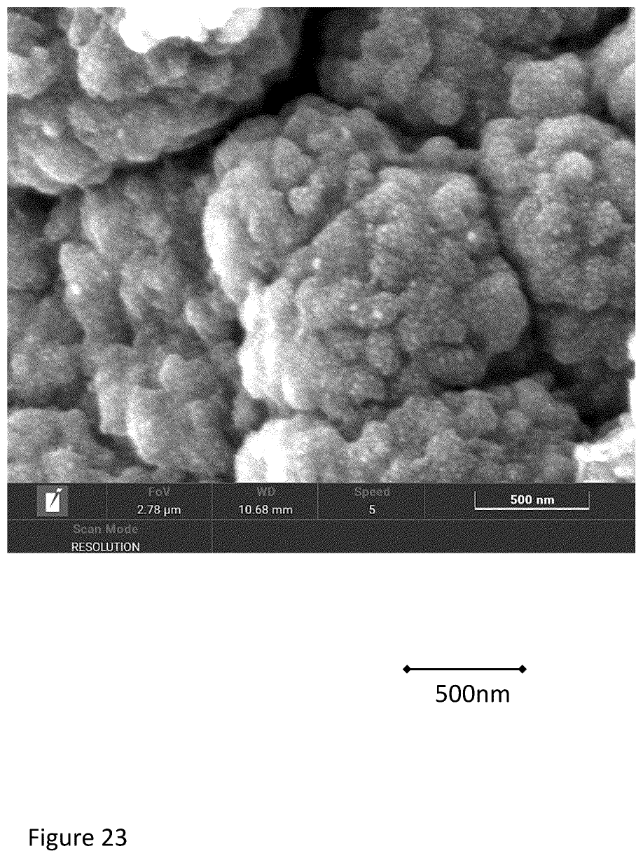

FIG. 23 is a SEM of a carbon nano-onion, see ‘Raman spectroscopy of polyhedral carbon nano-onions’. DOI: 10.1007/s00339-015-9315-9 and also ‘Carbon nano-onions: unique carbon nano-structures with fascinating properties and their potential applications’. DOI: 10.1016/j.ica.2017.07.021. The similarities to the Gii carbon foam are apparent.

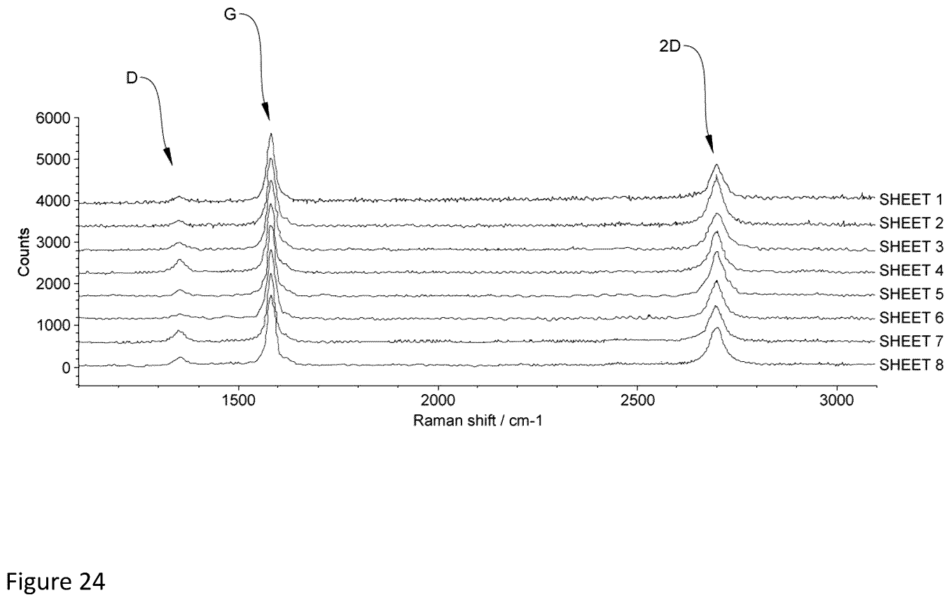

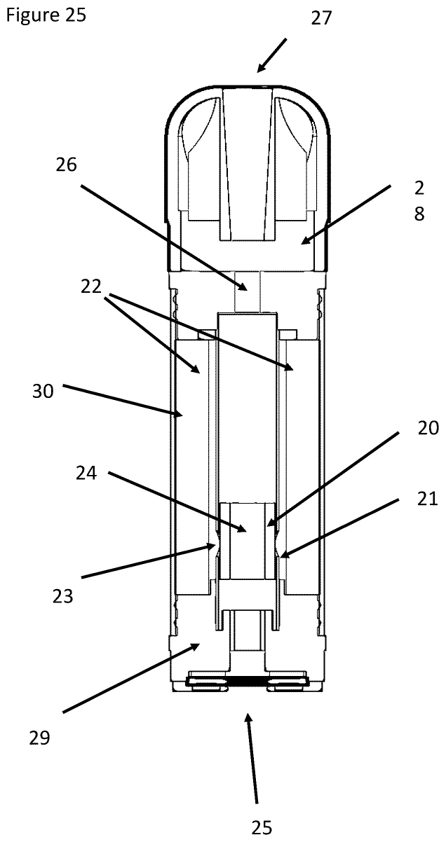

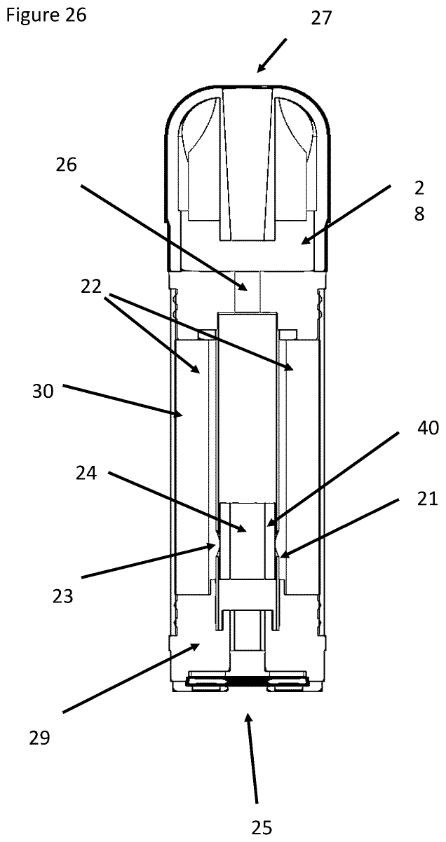

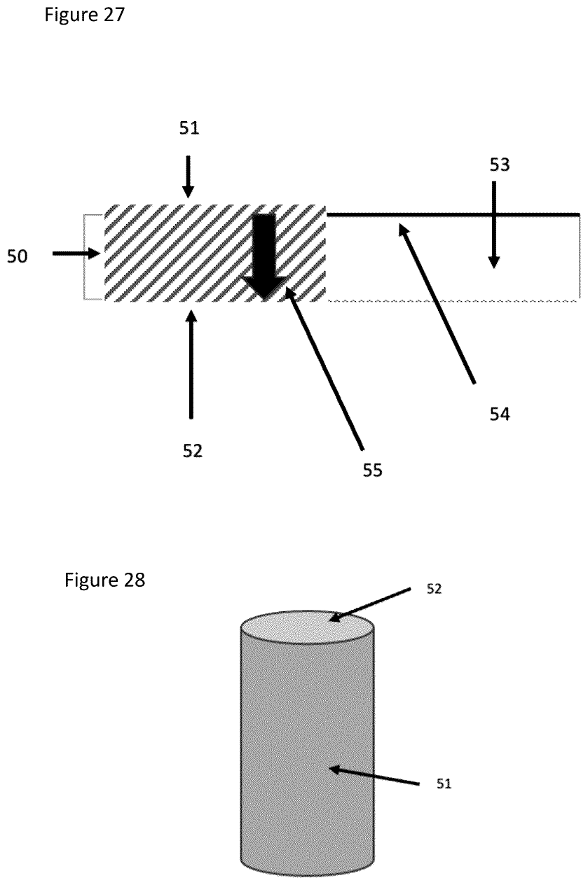

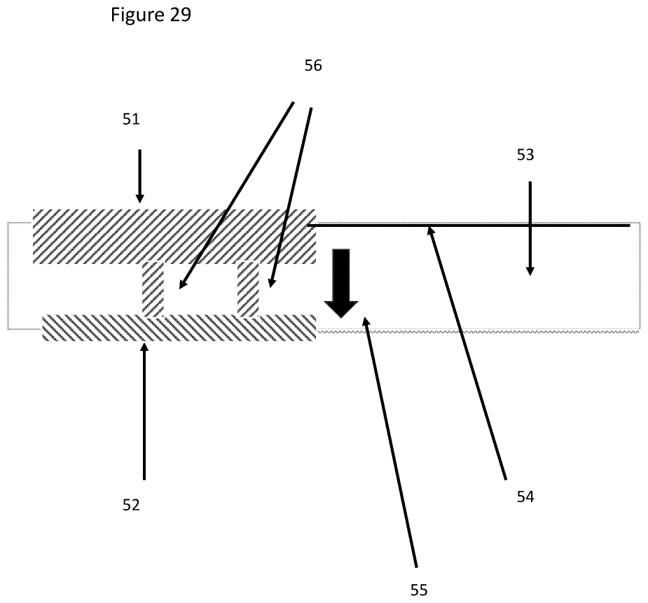

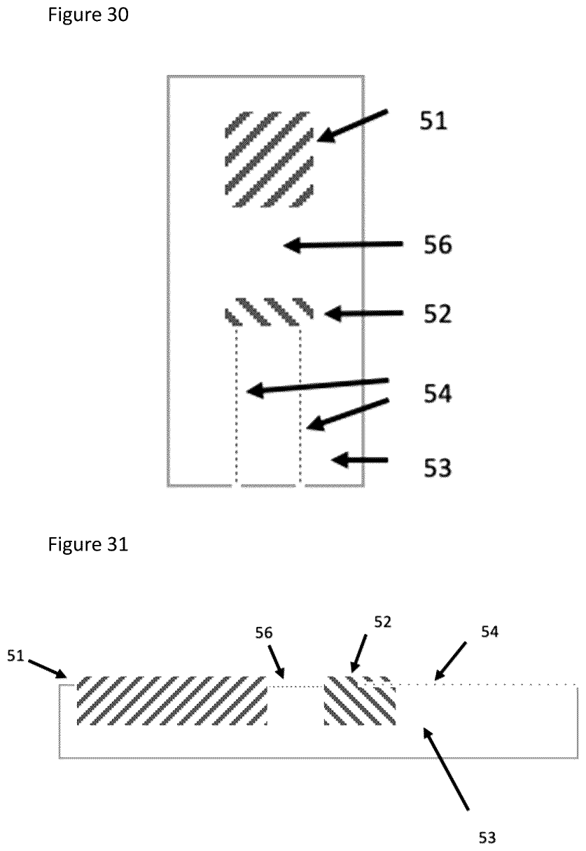

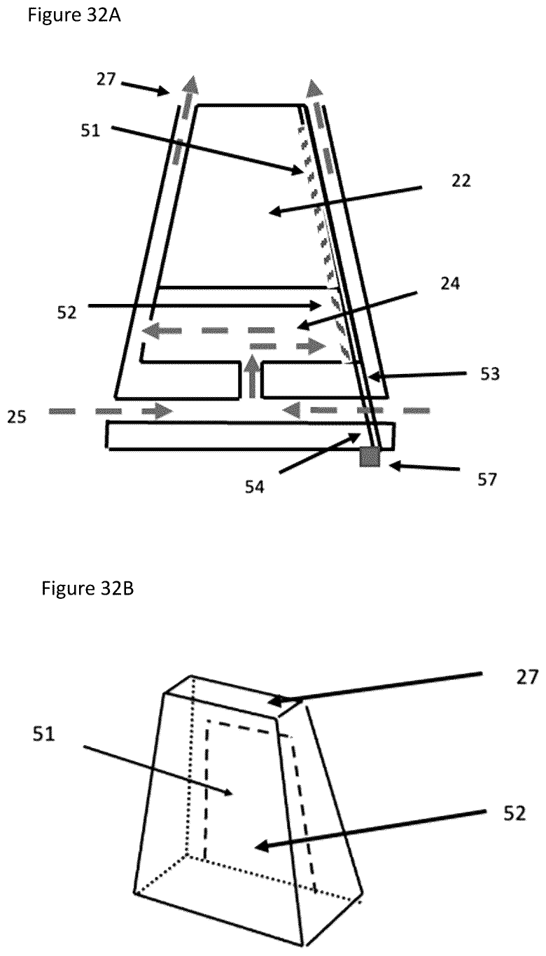

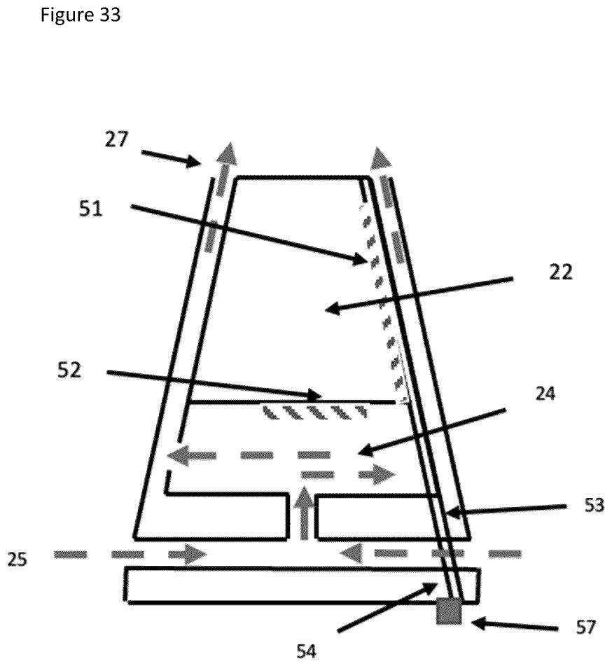

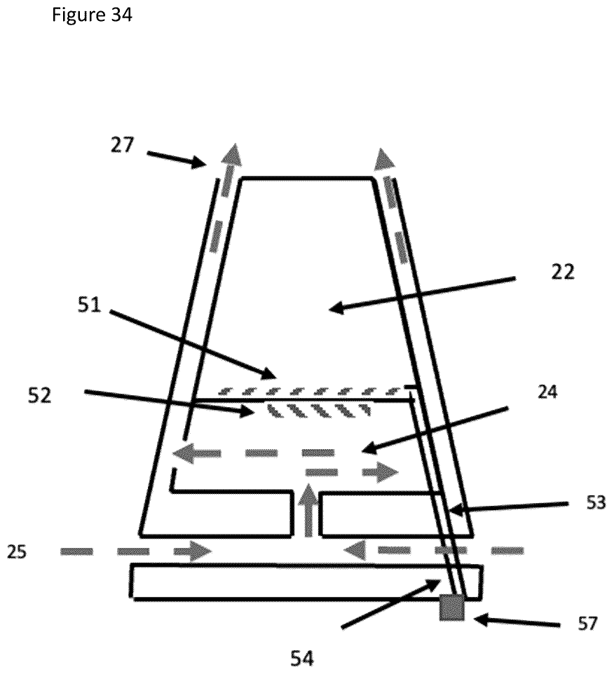

As noted earlier, graphene foam has a number of characteristics: it is hydrophobic, with low wettability. Raman analysis of a typical graphene foam reveals the following signatures: absence of a D peak; the 2D peak is higher than the G peak; the peak D: peak G ratio is close to zero. Yet the carbon foam generated using the Dual Laser process shares none of these characteristics; it is hydrophilic, with a contact angle below 20°; it lacks the tell-tale Raman spectrum signature of graphene: it shows a significant D peak; the 2D peak is significantly less than the G peak; the peak D: peak G ratio is significantly above zero. FIG. 24 shows the Raman shifts for eight sheets of carbon foam made using the Dual Laser process, showing the consistency of the Raman signature. It also shows a significant D peak; the 2D peak is less than the G peak; the peak D: peak G ratio is above zero. As we noted earlier, this Raman spectrum has much in common with carbon nano-onions. see also FIG. 15C, also from ‘Raman spectroscopy of polyhedral carbon nano-onions’. DOI: 10.1007/s00339-015-9315-9. The specific Dual Laser parameters used to create this low electrical resistance carbon nano-onion variant of Gii carbon foam are in Table 5 below:

TABLE 5

| | First Laser | Second laser |
|---|---|---|
| Laser machine | S300 | S300 |
| Laser wavelength (nm) | Flexx - IR 1064 nm | CO2 10600 nm |
| Power (Watts) | 11 | 36 |
| Speed (mm/s) | 810.11 | 188.15 |
| PPI (pulses per inch) | n/a | 1000 |
| Frequency (Hz) | 80000 | n/a |
| DPI (Dot/inch) | 1000 | 1000 |
| Offset (mm) | 0 | 15 |
| Passes | 1 | 1 |

We can generalise to the following:

A carbon foam material made, at least in part, by the method defined in any of Features A-L above and that is hydrophilic, with a contact angle below 20°.

A carbon foam material made, at least in part, by the method defined in any of Features A-L above and with a Raman spectrum exhibiting a significant D peak; the 2D peak is less than the G peak; the peak D: peak G ratio is above zero.

A carbon nano-onion material made, at least in part, by the method defined in any of Features A-L above.

Note that devices may be characterised by their use of these materials and so we can generalise to the following:

A device including a carbon foam material made, at least in part, by the method defined in any of Features A-L above and that is hydrophilic, with a contact angle below 20°

A device including a carbon foam material made, at least in part, by the method defined in any of Features A-L above and with a Raman spectrum exhibiting a significant D peak; the 2D peak is less than the G peak; the peak D: peak G ratio is above zero.

A device including a carbon nano-onion material, made, at least in part, by the method defined in any of Features A-L above.

Features A-L are summarised here for convenience:

### Group 1: Sub-Surface Carbon Foam

Feature A: Carbon foam created in a sub-surface region of a carbon pre-cursor material
Feature B: Carbon foam created in an encapsulated region of a carbon pre-cursor material
Feature C: Carbon foam created in a region of a carbon pre-cursor material, where the region has no substantial gas escape pathways
Feature D: Amorphous, non-graphene material adhering to the substrate

### Group 2: Dual Laser Processing

Feature E: Carbon foam created by laser ablating a sub-surface carbon foam region
Feature F: Non-graphene carbon foam created by laser ablating a sub-surface carbon foam region
Feature G: Dual lasers
Feature H: Electrical contacts positioned in carbon foam created by laser ablating a sub-surface carbon foam region
Feature I: Printing electrical contacts on the polyimide film and then creating the exposed carbon foam
Feature J: Tall tracks made in the carbon foam
Feature K: Applying the first and second lasers in different manufacturing facilities
Feature L: Scalable high speed manufacturing

### Section C: Carbon Foam Used in Vaping and THP (Tobacco Heated Product) Devices

### Section C.1 Walkthrough FIGS. 25-34

The carbon foam described in preceding sections has many properties that make it especially interesting in two fast-growing consumer categories, vaping and THP. In this Section C, we will outline these properties, referencing FIGS. 25-34.

The carbon foam components described in this section can be used in vaping devices (e.g. as a heating element to heat e-liquid) and as a susceptor in a THP stick. The carbon foam components can also be used in any other context where heating of a substance (liquid, gel or solid (powder or otherwise), or a combination) with minimal contaminants is needed-such as medical inhalation devices. The term ‘vaping’ or ‘vape’ device can include any type of vaping device, including a pod based device, or a single-use disposable device, or a multi-use disposable device, or mod type device, or a liquid refillable device.

The first use of Gii carbon foam we describe in detail is as a resistive heating element in a vaping device, to replace the conventional resistive heating element (typically a stainless steel metal mesh, or a stainless steel wire, or a metal layer bonded onto a ceramic substrate). Gii carbon foam heats uniformly and predictably when a current is passed through it, making it a good candidate for this application; we will detail later in this Section C that Gii carbon foam has multiple additional properties (e.g. antifouling; high wettability) that make it especially well suited to this application.

We start with an overview of a known type of vape device, as shown in FIG. 25. As shown in FIG. 25, in a conventional vaping device, a cylindrical metal mesh heating element 20 is placed inside a cylindrical flexible sleeve 21; the atomisable liquid, drawn from an e-liquid reservoir 22 (typically an open cell foam reservoir) passes through the sleeve 21 via a cotton wick (not shown) positioned transversely through apertures 23 in the sleeve 21. The e-liquid contacts the heated metal mesh 20 and vaporises in the cylindrical interior 24 of the metal mesh cylinder (a vapour creation chamber), with the vapour being sucked up with air entering an air inlet 25 and by the user through a vapour channel 26 and out through the outlet 27. The vape device also includes silicone seals 28, 29 at the top and bottom of the device to ensure no e-liquid leakage. A plastic case 30 encloses the foam liquid reservoir 22 and seals to the e-liquid seals 28, 29.

As shown in FIG. 26, a Gii carbon foam heating element 40 can be used to replace the standard mesh heater 20 and the cotton wick combination, keeping all other elements and manufacturing steps the same. The cylindrical Gii atomizer 40 includes contiguous carbon foam through its entire thickness (e.g. the thickness of the pre-cursor PI substrate) so that its outer surface draws liquid in from the foam reservoir 30 via apertures 23. The Gii carbon foam heating element 40 heats up and vapour escapes directly into the vapour creation chamber 24.

We will explain the advantages of using a Gii carbon foam heating element 40 over a conventional heating element atomiser below. Note that Gii carbon foam can be used in any category of vaping device, including a single use or disposable vaping device, or a refillable, multi-use vaping device.

FIG. 27 is a cross sectional schematic view through the Gii carbon foam heating element: this element is formed as a small rectangular sheet, tightly rolled up, as shown in FIG. 28 to substitute for the conventional cylindrical mesh heating element. Returning to FIG. 27 we can see that the Gii carbon foam constitutes the entire volume 50 of a section of the sheet; this entire volume is resistively heated; it will typically present a resistance of approximately 1 ohm, like a conventional metallic heater. The top section 51 in FIG. 27 which forms the outer surface (in dark grey) of the cylinder in FIG. 28, faces and is in liquid contact with the liquid reservoir and draws liquid from that reservoir; that liquid is heated as it passes through (indicated by the arrow 55) the bulk 50 of the Gii carbon foam material and then evaporates at the lower surface 52, which forms the inner surface (in light grey) of the cylinder in FIG. 28, which is exposed to the vapour creation chamber. As heated liquid evaporates from this inner heated surface 52, that draws further liquid through the bulk 50 of the Gii carbon foam, due to the extreme wettability and porosity of the carbon foam; it is a highly effective wicking material, with uniform and rapid wetting. The combined, integrated heater and wick is formed on a single thin piece of high temperature polyimide film 53, safe and non-combustible to 350C (which is in excess of the typical temperatures the atomiser will be heated to). Silk screen printed electrodes 54 provide a power path to the heating element. Note that FIG. 27 is a cross section view through the combined heating element and wick; in plan view, the carbon foam can form a sinuous track, or any other pattern designed to evenly heat and wick in a controlled manner the e-liquid.

Also, note that the Gii carbon foam both acts as a liquid wick, and directly heats the liquid; there is no need for the Gii carbon foam to heat a separate heat-conductive layer, which in turn then heats the liquid: instead, the Gii carbon foam is in direct contact with the liquid to be heated. In an alternative implementation, the Gii carbon foam can be used to heat a heat-conductive layer (which may be separate from the Gii carbon foam, or formed from the underlying substrate that is used to make the Gii carbon foam), and that heat-conductive layer then heats the liquid. This alternative implementation can however be more complex to manufacture, especially where it requires the presence of an additional and separate heat-conductive layer, and is hence not the preferred option.

Carefully controlling the flow of liquid from the liquid absorption region through to the heating element is key to avoid liquid leakage. Whilst that may be possible with a single, generally uniform Gii carbon foam structure, as shown schematically in FIG. 27, it is also possible to create internal 3D structures in the Gii fabrication process. We leverage this capability in this next variant, shown in FIG. 29, where we separate the Gii carbon foam liquid absorption region 51 from the Gii heating region 52 by internal micro-channels 56 that limit and control the capillary flow of liquid to the heating section 52.

The previous variants re-use the structure of a conventional vape, essentially just replacing the mesh and cotton combination with a single Gii carbon foam structure. More radical variants are also possible that have the potential to radically reduce the component count, enabling rapid, fully automated atomiser assembly and hence decreased BOM cost.

FIG. 30 shows a schematic plan view of a Gii carbon foam integrated atomizer, combining e-liquid porous wicking section 51 (in liquid contact with the liquid reservoir-typically with 2 mL capacity), a single capillary micro-channel 56, a heating section 52 and electrical power leads 54, all as a single, low-cost integrated item, fabricated in a single multi-stage process, and all fabricated on a single piece of high temperature PI (polyimide) substrate 53.

A schematic side view of this structure is shown in FIG. 31. Maintaining this structure as a flat unit enables a highly simplified, easy to assemble tip or pod for a vaping device (including a single use or disposable vaping device, or a refillable, multi-use vaping device), as shown in FIG. 32.

In FIG. 32A, we can see that the liquid wicking section 51 runs along one surface of the liquid reservoir 22 and continues, as a flat structure, to become the heater section 52, which is inside the atomisation chamber 24. This enables an especially flat tip or pod to be made. The carbon foam structure includes screen printed electrodes 54, which terminate in an electrical connector 57, which contacts an electrical connector in the body of the vape device (not shown) which includes the battery and power electronics.

Because Gii carbon foam and the underlying substrate is flexible, we can also bend the heating element 52 around so that it sits horizontally, as shown in FIG. 33 as it would in a conventional ceramic-type atomiser.

We can even bend the Gii carbon foam atomiser through 180 degrees, so that the porous wicking region 51 that is in the liquid reservoir 22 is now at the base of the reservoir 22, and the heating element 52 sits directly underneath it, as shown in FIG. 34. Equally, this structure could be formed not from a planar Gii carbon foam sheet that is bent through 180 degrees, but instead with a single integrated Gii carbon foam structure where the porous region forms the top layer, facing up and into the reservoir, and the heating region faces downwards and into the vapour creation chamber.

### Section C2: Features of Different Implementations

In this Section C2, we focus on a number of different Features, many of which are implemented in the devices described earlier in this Section C. Note that any one or more of these Features 1-22 may be combined together.

### Design and Fabrication

Feature 1: Gii carbon foam can be formed into an atomising device component such as a resistive heating element. Gii carbon foam has many properties that make it ideal for this role. For example: low driving voltage, high steady-state temperature, ultrafast response and excellent flexibility are all properties that may be seen in Gii carbon foam. As noted above, the carbon foam heating element may directly heat the liquid to be atomised, i.e. it does not have to heat a separate heat conductive element that is itself in direct contact with the liquid to be heated. Gii carbon foam's anti-fouling properties and high wettability make direct contact between the carbon foam and the atomisable liquid being heated the preferred route.

We can generalise to:

A method of manufacturing a component made substantially of carbon foam, for an atomising device; in which the method includes the step of using a high temperature process generated by a laser beam directed at a carbon-based pre-cursor material, such as a polymer or polyimide sheet material, to manufacture a carbon foam component that is electrically conductive, and non-metallic and capable of wicking an atomisable liquid.

A method of manufacturing a component, made substantially of carbon foam, for a vaping device; in which the method includes the step of using the method defined in any of Features A-L above, to manufacture a carbon foam component that is electrically conductive, non-metallic and capable of wicking an atomisable liquid.

We can also generalise to:

An atomising device including a carbon foam component, such as a heating element or wick or combined heating element and wick, made, at least in part, by the method defined above.

The atomising device may be a heater element, such as a heater element in or for a vaping device or medical inhaler device. The atomisable liquid may include a medication or therapeutic drug, or may include e-liquid for a vaping device.

Feature 2: Because Gii carbon foam is both porous to e-liquid and can be ohmically heated, Gii carbon foam can be fabricated to form an integrated structure that includes both the liquid ingest or wicking function (otherwise performed by porous cotton or foam, or a ceramic element—the function is to transfer e-liquid from an e-liquid reservoir (typically storing no more than 2 mL of e-liquid to the heating element) and also the liquid heating function (otherwise performed by a steel wire wound around cotton wool/foam or a metal sintered coating on a ceramic base). For example, the heating element and the liquid porous wicking element can be formed from the same polymer pre-cursor material, and can be a single integrated or homogenous unit, with one portion of the unit serving as the liquid wicking part and another portion of the unit serving as the heating part. The liquid wicking part could include one face of the carbon foam structure (typically planar) and the heating part could include the opposite face. Or the liquid wicking part and heating parts could be co-planar, but physically separate.

The manufacturing parameters can be tuned so that the carbon foam that forms the porous element for ingesting liquid has properties optimised for that function, and likewise the carbon foam that forms the heating element has properties optimised for that function—e.g. different parameters are used for the fabrication of each of these elements.

We can generalise to:
A method of manufacturing (i) a heating element, such as for a vaping device and (ii) a liquid porous wicking element, such as for a vaping device, configured to provide liquid to the heating element, both elements being made substantially of carbon foam and being electrically conductive, non-metallic, and porous to e-liquid;
and in which carbon foam heating element and the carbon foam liquid porous element, are manufactured using (a) a high temperature laser-based process applied to a carbon pre-cursor material, such as a polymer or polyimide sheet material or (b) the method defined in any of Features A-L above, and in which the heating element and the liquid porous element are manufactured so as to form an integrated structure.

We can generalise further to:
A method of manufacturing (i) a first component and (ii) a second component, both components being made substantially of carbon foam and being electrically conductive, non-metallic, and capable of wicking an atomisable liquid;
and in which both components are manufactured using (a) a high temperature laser-based process applied to a carbon pre-cursor material, such as a polymer or polyimide sheet material or (b) the method defined in any of Features A-L above, and in which the components are manufactured so as to form an integrated structure.

The first component may be a heater element and the second component a liquid wicking element.

We can also generalise to:

An atomising device manufactured by this method.

Feature 3: High speed, ultra-high volume reel to reel or reel to sheet Gii carbon foam fabrication of a complete, integrated component is possible: the component combines (a) Gii carbon foam porous wicking sections that transfers liquid from a local reservoir and (b) a Gii carbon foam heating element (e.g. co-planar with the porous section, or beneath it using the G-Thru 3D process described below) that is supplied with liquid from the Gii carbon foam porous wicking sections, with all components fabricated on the same polymer (e.g. PI) substrate (separate and then joined PI substrates is also possible).

We can generalise to:
A method of manufacturing a carbon foam component; in which the method includes passing a continuous reel of a carbon pre-cursor material through a sequence of reel to reel or reel to stack operations required to manufacture the carbon foam component using, at least in part, (a) a high temperature laser-based process applied to the carbon pre-cursor material, such as a polymer or polyimide sheet material or (b) the method defined in any of Features A-L defined above.

The component may be a component for a vaping device, such as a heating element or a liquid porous element.

We can also generalise to:

An atomising device manufactured by this method.

Feature 4: Gii carbon foam can be fabricated with a Gii carbon foam micro-channel leading from the Gii carbon foam porous wicking element (e.g. the layer that draws in liquid from the local reservoir) to the Gii carbon foam heating element, giving a controlled capillary-based release of liquid to the heating element, with no leakage or excessive flooding of the heating element or excessive heat transfer to the liquid in the reservoir that feeds the micro-channel; this re-purposes the kind of micro-channel used in Gii carbon foam based micro-fluidics devices, otherwise used in biosensors. Note we generally use just a single micro-channel so that there is no current path through the porous element (with two micro-channels, there could be a current path back through the porous element, leading to undesirable heating of that porous element).

We can generalise to:
A method of manufacturing a component, made substantially of carbon foam, for an atomising device; in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive, non-metallic, and is porous to e-liquid,
and in which the component is a micro-channel configured to provide a controlled delivery of atomisable liquid from a liquid reservoir to a heating element.

We can also generalise to:

A vaping device including a micro-channel made, at least in part, by the method defined above, the micro-channel configured to provide a controlled delivery of atomisable liquid from a liquid reservoir to a heating element.

Feature 5: The atomiser can include power electrodes for the Gii carbon foam heating element, all fabricated as part of the same Gii carbon foam manufacturing process—e.g. directly on to the PI substrate that the Gii carbon foam is formed in, using a silk screen process. The electrodes may be conductive ink, or silver, or carbon foam.

We can generalise to:
A method of manufacturing a component, made substantially of carbon foam, for an atomising device; in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive, non-metallic, and is capable of wicking an atomisable liquid;
in which the component is a heating element and the method includes the step of fabricating (e.g. by silk screening) electrical power electrodes for the heating element, on to the same substrate as the heating element and as part of the same fabrication process used to manufacture the heating element.

We can also generalise to: An atomising device including a component and electrical power electrodes for the component, manufactured using the method defined above.

Feature 6: All the main function elements needed for an atomiser can be fabricated using the same multi-step process used to fabricate Gii carbon foam based devices: (a) a Gii carbon foam porous wicking element/layer that transfers liquid from a local reservoir; (b) a Gii carbon foam microchannel or structure that enables liquid to flow from the porous element in a controlled manner without leakage; (c) a Gii carbon foam heating element that is supplied with liquid from the Gii microchannels and (d) electrical electrodes that provide power to the Gii carbon foam heating element.

We can generalise to:
A method of manufacturing components made substantially of carbon foam, for an atomising vaping device; in which the method includes the step of using (a) a high temperature laser-based process applied to a carbon pre-cursor material, such as a polymer or polyimide sheet material or (b) the method defined in any of Features A-L above, to manufacture the carbon foam components that are electrically conductive, non-metallic, and porous to e-liquid;
in which the components are (a) a carbon foam porous wicking element/layer that transfers liquid from a local reservoir; (b) a carbon foam microchannel or structure that enables liquid to flow from the porous element in a controlled manner without leakage; (c) a carbon foam heating element that is supplied with liquid from the microchannels;
and the method includes the step of fabricating (e.g. by silk screening) electrical power electrodes for the heating element, on to the same substrate as the heating element and as part of the same fabrication process used to manufacture the heating element.

We can also generalise to: An atomising device manufactured by this method.

Feature 7: Gii carbon foam is typically fabricated on a high temperature PI film substrate (stable up to 350 C) that is non-porous and hence provides a liquid impermeable border to the Gii carbon foam structures; that border can be designed to provide a non-porous liquid barrier, to prevent liquid leakage. So in the schematic in FIG. 34, the base of the liquid reservoir presses against the Gii carbon foam structure, making a seal against the Gii carbon foam structure and rear face of the tip that the Gii carbon foam structure is mounted against; the inherent compressibility of the Gii carbon foam structure (and that the micro-channel that lets liquid pass to the heating element extends a small amount into the depth of the PI film and is not solely on the surface of the PI film) enables a liquid-tight seal to be formed.

We can generalise to:
A method of manufacturing a component, made substantially of carbon foam, for an atomising device; in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive, non-metallic, and is porous to e-liquid;
and in which a part of the carbon-based pre-cursor material is shaped or configured as a perimeter, border or surround to a carbon foam component, such as a heating element or liquid wicking element, to prevent liquid leakage.

We can also generalise to: An atomising device manufactured by this method.

Feature 8: The flexible PI substrate, the carbon pre-cursor material, can be bent or shaped into a curved surface, e.g. a cylindrical etc forms, without risk of flaking the Gii carbon foam structures (e.g. heating element, liquid porous element etc). Other curved or folded substrates are possible too—e.g. glass, silicon.

We can generalise to:
A method of manufacturing a component, made substantially of carbon foam, for an atomising vaping device; in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive, non-metallic, and is porous to e-liquid;
and in which a part of the carbon-based pre-cursor material is a substrate that is folded or curved when positioned in the atomising device.

We can also generalise to: An atomising device manufactured by this method.

Feature 9: The Gii carbon foam porous liquid ingest layer can also be thermally insulating-hence preventing unwanted heating of the liquid in the liquid reservoir (unwanted heating can otherwise make it hard to maintain the heating element at a stable set point temperature). Conventional graphene can be highly thermally conductive (e.g. 5000 W/mk) whereas polyimide tape is thermally insulating (approx. 2 W/mk); Gii carbon foam has an in-plane thermal conductivity of approximately 4 W/mk. In-plane thermal diffusivity is 1-2 mm2/s. Specific heat per unit volume is approximately 2-3 MJ/m3K.

We can generalise to:
A method of manufacturing a component, made substantially of carbon foam, for an atomising device; in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive, non-metallic, and is capable of wicking an atomisable liquid;
and in which the component, such as a liquid wicking element, is configured to thermally insulate a liquid reservoir in the atomising device from heat generated by the heating element in the atomising device.

We can also generalise to: An atomising device manufactured by this method.

### Vaping Performance

Feature 10: Gii carbon foam has a readily measurable temperature co-efficient of resistivity (approx. −0.0013/C), and can be efficiently ohmically heated; the vape device can accurately infer the temperature of a Gii carbon foam heating element from the voltage/current delivered. A Gii carbon foam heating element also rapidly heats up to a closed loop control setpoint and can be controlled to maintain that setpoint using PWM closed loop feedback control and the known temp co-efficient of resistivity.

We can generalise to:
A method of manufacturing a component, made substantially of carbon foam, for an atomising device; in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive, non-metallic, and is porous to e-liquid;
and in which the component is a heating element characterised by a known or measured temperature co-efficient of resistivity and is configured to be heated using a PWM closed loop feedback control system that uses the known temperature co-efficient of resistivity.

We can also generalise to: An atomising device manufactured by this method, and in which the heating element is characterised by a known or measured temperature co-efficient of resistivity and is configured to be heated using a PWM closed loop feedback control system that uses the known temperature co-efficient of resistivity.

Feature 11: A Gii carbon foam heating element exhibits rapid, even, isotropic, resistive heating (e.g. it can maintain an even 280 C or whatever level is sought across its entire surface), with no localised hot spots (e.g. over 400 C) that could generate aldehydes etc. Because the Gii heating element can maintain a stable set-point high temperature across its entire surface, that leads to predictable, repeatable, high quality performance, delivering target nicotine (or cannabinoid etc) output, with minimal puff-to-puff or intra-puff variation and optimal flavour.

We can generalise to:
A method of manufacturing a component, made substantially of carbon foam, for an atomising device; in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive, non-metallic, and is porous to e-liquid;
and in which the component is a heating element configured to heat evenly and uniformly across its surface.

We can also generalise to: An atomising device manufactured by this method. And to a vaping device manufactured using the above method, in which the component is a heating element configured to heat evenly and uniformly across its surface.

Feature 12: Gii carbon foam has extreme wettability for e-liquids, so a Gii carbon foam heating element can readily and evenly absorb e-liquid from a local reservoir and the e-liquid will spread evenly over the heating surface (contributing to even heating, even vapour creation across the entire surface, avoiding localised dry areas).

We can generalise to:
A method of manufacturing a component, made substantially of carbon foam, for a vaping device; in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive, non-metallic, and is porous to e-liquid;
and in which the component is wettable with a contact angle below 20°.

We can also generalise to: An atomising device manufactured by this method, in which the heating element is wettable with a contact angle below 20°.

Feature 13: Gii has excellent anti-fouling properties, so minimising VG-based caramelisation and extending the safe lifetime of the heating element-potentially to thousands of puffs.

We can generalise to:
A method of manufacturing a component, made substantially of carbon foam, for an atomising device; in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive, non-metallic, and is porous to e-liquid;
and in which the component is a heating element with an anti-fouling property enabling the heating element to provide in excess of 300 puffs in normal use without substantial carbonisation or caramelisation.

We can also generalise to: An atomising device manufactured by this method.

Feature 14: Gii carbon foam can be fabricated into different (e.g. complex, 3D) shapes, to optimise contact of the vortex flow with the Gii carbon foam heater and hence optimise nicotine/cannabinoid/terpenoid/flavonoid content and improving vapour flavour.

We can generalise to:
A method of manufacturing a component, made substantially of carbon foam, for an atomising vaping device; in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive, non-metallic, and is porous to atomisable liquid;
and in which the component is a heating element is formed into a shape that alters the air flow over the heating element in a manner, for example in a manner that increases nicotine or cannabinoid or terpenoid or flavonoid content or improves vapour flavour of inhaled vapour or improves the presence of other vapour constituents.

We can also generalise to: An atomising device manufactured by this method. And to a vaping device including a carbon foam heating element made by the method defined above, and in which the heating element is formed into a shape that alters the air flow over the heating element in a manner that increases nicotine or cannabinoid or terpenoid or flavonoid content or improves vapour flavour of inhaled vapour.

### Vaping Safety

Feature 15: Gii will not break down and release undesirable compounds at normal operating temps. It is stable at high temperature (e.g. is created on a High Temp PI film substrate, stable at 350 C).

We can generalise to:
A method of manufacturing a component, made substantially of carbon foam, for an atomising device; in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive, non-metallic, and is porous to e-liquid;
and in which the carbon pre-cursor that is a high temperature PI film that is substantially thermally stable at 350 C.

We can also generalise to: An atomising device manufactured by this method.

Feature 16: When thermal breakdown occurs, combustion products from a Gii carbon foam heating element are only minimal amounts of CO and H2. So even in a dry vape or fault condition, there are no harmful vapour constituents. There is hence minimal risk of metals etc in the vapour: a Gii atomiser can set a new benchmark for vapour safety, establishing a high bar for future regulatory (e.g. PMTA) approvals that conventional atomisers may struggle to meet.

We can generalise to:
A method of manufacturing a component, made substantially of carbon foam, for an atomising device; in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive, non-metallic, and is porous to e-liquid;
and in which the combustion products of the component are substantially limited to CO and H2.

We can also generalise to: An atomising device manufactured by this method.

The Gii Carbon Foam Nano-Material has Numerous, Unique Properties as a Heating Element for a Non-Liquid Device, Such as a Medical Inhaler, or as a Heating Element in a Heated Tobacco Stick (e.g. THP (Tobacco Heated Products, or ‘Heat-not-Burn’ Stick)

Feature 17: Gii carbon foam can be inductively heated using a typical 5 MHz to 7 MHz driving current; it is the ideal target or susceptor for an inductively heated tobacco stick since it is very low cost, can be formed as a thin flexible strip, can heat evenly and uniformly across its surface; is stable at temperatures as high as 350 C (the typical maximum temperature inside a heated tobacco stick like iQoS Terea) since it can be formed from the carbon pre-cursor that is a high temperature PI film that is substantially thermally stable at 350 C. It releases no metallic combustion products, unlike conventional metallic susceptors; its combustion products that are substantially limited to very small amounts of CO and H2. It can be formed into a shape that alters air flow through past the susceptor in a manner that increases nicotine or cannabinoid or terpenoid or flavonoid content or improves vapour flavour of inhaled vapour.

We can generalise to:
A method of manufacturing a component, made substantially of carbon foam, for a tobacco heated product stick in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive;
and in which the component is an inductively heated target or susceptor configured to be used in the tobacco heated product stick.

Another aspect is:

A tobacco heated product stick including a carbon foam inductively heated target or susceptor made, at least in part, by the method defined above.

Feature 18: As noted above, Gii carbon foam will not break down and release undesirable compounds at normal operating temps. It is stable at high temperature (e.g. 350 C—it is created on a High Temp PI film substrate, itself stable at 350 C).

We can generalise to:
A method of manufacturing a component, made substantially of carbon foam, for a tobacco heated product stick in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive;
and in which the component is an inductively heated target or susceptor configured to be used in the tobacco heated product stick and is stable at 350 C.

Another aspect is: A THP stick including a carbon foam target or susceptor manufactured, at least in part, by this method and that is stable at 350 C.

Feature 19: When thermal breakdown occurs, combustion products from a Gii carbon foam heating element are limited to small quantities of only CO and H2. So even in a dry vape or fault condition, there are no harmful vapour constituents. There is hence minimal risk of metals etc in the vapour, unlike conventional metallic susceptors: a Gii carbon foam based tobacco heated product stick can set a new benchmark for THP vapour safety, establishing a high bar for PMTA approvals that conventional atomisers may struggle to meet. We can generalise to:
A method of manufacturing a component, made substantially of carbon foam, for a tobacco heated product stick in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive;
and in which the component is an inductively heated target or susceptor for which any combustion products are limited to CO and H2.

We can also generalise to: A THP stick including a carbon foam target or susceptor manufactured, at least in part, by this method.

Feature 20: Because the Gii carbon foam inductively heated susceptor strip is thermally conductive, and very flexible, that means the Gii carbon foam susceptor strip can be positioned within the body of the tobacco plug in the heated product stick in a manner that optimises the vapour performance (e.g. optimal nicotine, flavour and/or warmth): in a conventional tobacco heated product stick, the inductively heated susceptor item is typically a flat strip of metal running across the diameter of a cylindrical tobacco plug—and there is limited scope for designing the inductively heated item in a way that e.g. evenly heats the tobacco substance. Instead, the tobacco closest to the flat metal strip is heated far more than the tobacco furthest from the flat metal strip. But with Gii carbon foam, we can have, for example, a thin, planar, spiral coil in the tobacco plug (like a sponge roll cake) approximately concentric with the outer cylindrical surface of the tobacco plug, so that there is much less variation in the distance of all tobacco regions from the Gii susceptor strip, hence leading to more even heating, and better control of the constituents in the vapour (e.g. more accurate delivery of nicotine).

We can generalise to:
A method of manufacturing a component, made substantially of carbon foam, for a tobacco heated product stick in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive;
and in which the component is an inductively heated target or susceptor and is configured to be positioned inside a tobacco plug in the stick and is shaped to include a curved section.

We can also generalise to: A THP stick including a curved carbon foam target or susceptor manufactured, at least in part, by this method.

Feature 21: Tobacco heated product devices can heat the stick in several ways. In the preceding section, we have focused on inductive heating. Another approach is resistive heating, e.g. by a resistively heated metal blade that penetrates the tobacco plug, or a resistively heated cylindrical metal element that concentrically surrounds the tobacco plug in the stick. A Gii carbon foam resistively heated element can be used to replace the metal parts in both of these options.

We can generalise to:
A method of manufacturing a component, made substantially of carbon foam, for a tobacco heated product stick in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive;
and in which the component is a blade configured to penetrate a tobacco plug or as a concentric heater that surrounds the tobacco plug.

We can also generalise to: An atomising device including a blade configured to penetrate a tobacco plug or as a concentric heater that surrounds the tobacco plug, manufactured, at least in part, by this method.

### Feature 22: Therapeutic Uses

We can generalise to:

A method of manufacturing a component, made substantially of carbon foam, for a therapeutic drug inhalation device, in which the method includes the step of using (a) a high temperature laser-based process applied to a carbon pre-cursor material, such as a polymer or polyimide sheet material or (b) the method defined in any of Features A-L above, to manufacture a carbon foam component that is electrically conductive;

and in which the component is a heating element for the therapeutic drug inhalation device.

Optional features include:
the carbon pre-cursor material is high temperature polyimide, stable at 350 C.
any combustion products of the heating element are limited to CO and H2.

Another aspect is: A therapeutic drug inhalation device, including a carbon foam including a heating element made, at least in part, by the method defined above.

Whilst our specific focus here is to explore applications for the material fabricated using any of the methods described in Features A-L in Section A, it is possible that some of the device structures described in this Section C can be implemented using a different carbon material, such as conventional laser induced graphene foam. To further generalise, we cover also any method or device where the fabrication method is not limited to that described in Features A-L, but instead extends to any known graphene or carbon foam fabrication method. To generalise yet further, we cover also any method or device as described in Features 1-22 in this Section C, but where the material is not limited to graphene or carbon foam, but any other material which is electrically conductive yet non-metallic, such as a conductive non-metallic ceramic; for Features 1-16 (i.e. the vaping specific features), the material is porous to e-liquid. For Features 17-21 (i.e. the THP specific features), the material can be inductively heated (e.g. with a HF magnetic field).

### Section C.3—Advantages of Using Gii Carbon Foam in Vaping and HNB Devices

In this Section C.3, we re-cap on the main advantages of using Gii carbon foam in vaping and HNB devices; we categorise the advantages into three areas: Safety, Performance and Manufacturability.

### The Gii Nano-Material has Numerous, Unique Properties for a Vape Heating Element: Safety

Even, isotropic, resistive heating because of high thermal conductivity (e.g. can maintain an even 280 C or whatever level is sought across its surface), with no hot spots (e.g. over 400 C) that could generate aldehydes etc.
Gii will not break down and release undesirable compounds at normal operating temp.
Stable also at high temperature (egg can be created on a High Temp PI film substrate, stable even at 350 C).
When thermal breakdown occurs, combustion products are only CO and H2. So even in a dry vape condition, there are no harmful vapour constituents.
Minimal risk of metals etc in the vapour: can set a new benchmark for vapour safety, establishing a high bar for PMTA approvals that conventional atomisers may struggle to meet.
Can be created on a PI film substrate which is entirely non-porous, facilitating manufacture of leak-free atomisers
Measurable co-efficient of resistivity, so you can accurately infer temp of the vape heating element from the voltage/current delivered
Rapidly heats up to a setpoint and can be controlled to maintain that setpoint using PWM closed loop feedback control and the known temp co-efficient of resistivity.

### The Gii Nano-Material has Numerous, Unique Properties for a Vape Heating Element: Performance

Can maintain a stable set-point high temperature across its entire surface, leading to predictable, repeatable, high quality performance, delivering target ACM with minimal variation and optimal flavour
Extreme wettability for e-liquids, so a Gii heating element can readily transfer or wick e-liquid from a local reservoir and the e-liquid spreads evenly over the heating surface (contributing to even heating and avoiding ‘dry vape’).
Excellent anti-fouling properties, so minimising VG-based caramelisation and extending the safe lifetime of the heating element-potentially to thousands of puffs.
Can be formed into different (e.g. complex, 3D) shapes, to optimise contact of the vortex flow with the Gii and hence optimise nicotine/cannabinoid/terpenoid/flavonoid content and improving vapour flavour

### The Gii Nano-Material has Numerous, Unique Properties for a Vape Heating Element: Manufacturability

Mass manufacturable at very low cost, comparable to simple acid etched 316L steel wire
Integral PI film border to the Gii can be designed to provide a liquid barrier, to prevent liquid leakage.
Easy to print electrode contacts for the Gii heating element as part of the manufacturing process—i.e. directly on to the PI substrate that the Gii is formed in.
Can be formed into different (complex) shapes that include, in a two-part hybrid 3D structure, the liquid ingest and wicking function (otherwise performed by cotton or foam, or a ceramic) and also the heating function (otherwise performed by a steel wire wound around cotton wool/foam or a metal sintered coating on a ceramic base).
The Gii liquid ingest and wicking layer is also highly thermally insulating-hence preventing unwanted heating of the liquid in the liquid reservoir (unwanted heating can otherwise make it hard to maintain the heating element at a stable set point temp.)
High speed, ultra high volume reel to reel or reel to sheet manufacture of complete, integrated component that combine (a) Gii porous sections that transfer liquid from a local reservoir and (b) a Gii heating element (e.g. all formed in a 3D structure created using the G-Thru 3D process) that is supplied with liquid from the Gii porous sections and (c) electrical electrodes that provide power to the Gii heating element—with all components manufactured on the same PI substrate, or separate but joined PI substrates.
Flexible PI substrate and can be bent into e.g. cylindrical etc forms without risk of flaking.
Other substrates possible too—e.g. glass, silicon.

1. A method of manufacturing a component or components, each made substantially of carbon foam, for an atomising device, in which the method includes the step of using a high temperature process generated by a laser beam directed at a carbon-based pre-cursor material, such as a polymer or polyimide sheet material, to manufacture a carbon foam heating component or components that are electrically conductive, and non-metallic and capable of wicking an atomisable liquid and heating that liquid;
the carbon pre-cursor material, in which parameters of the laser beam have been selected to create a carbon foam in that sub-surface or encapsulated region.

2. The method of claim 1, in which parameters of the laser beam have been selected to create a carbon foam solely in that sub-surface or encapsulated region and in which no substantial gas escape pathways to a surface of the pre-cursor material are created by the laser beam.

3. The method of claim 1 comprising the step of irradiating an internal region of the carbon pre-cursor material, positioned on a substrate, in which parameters of the laser beam have been selected to create a carbon foam in that region and to create a disorganised, amorphous, non-graphene material between the carbon foam region and the substrate; in which that disorganised, amorphous, non-graphene material is adhering or otherwise attaching directly to the substrate.

4. The method of claim 1 comprising the steps of (a) the laser beam irradiating an encapsulated or sub-surface region of the carbon pre-cursor material, to create a carbon foam in that encapsulated or sub-surface region and a disorganised, amorphous non-graphene substance above the carbon foam, and then (b) laser ablation or treatment to remove the disorganised, amorphous non-graphene substance and to expose and/or transform at least some of the carbon foam.

5. The method of claim 1 comprising the steps of (a) the laser beam irradiating an encapsulated or sub-surface region of the carbon pre-cursor material to create a carbon foam in that encapsulated or sub-surface region in the carbon pre-cursor material, and a disorganised, amorphous non-graphene substance above the carbon foam and then (b) laser ablation or treatment to remove the disorganised, amorphous non-graphene substance and expose at least some of the underlying carbon foam and transform at least some of that underlying carbon foam into a non-graphene carbon foam.

6. The method of claim 1 comprising the steps of (a) using the laser beam operating at a first band to irradiate an encapsulated or sub-surface region of the carbon pre-cursor material below a surface of the material, to create carbon foam in that encapsulated or sub-surface region, and then (b) using a laser beam operating at a second band to remove or ablate material sitting above the carbon foam, to expose and/or transform at least some of the carbon foam.

7. The method of claim 1 in which the component is an integral structure comprising both a heating element and a porous wicking element configured to provide atomisable liquid to the heating element.

8. The method of claim 1 in which the component is an integral structure comprising both a heating element and a liquid porous wicking element, and the manufacturing parameters for each element have been selected so that the carbon foam that forms the porous element for wicking the liquid has properties optimised for that function, and the carbon foam that forms the heating element has properties optimised for that function.

9. The method of claim 1 in which at least a part of the carbon-based pre-cursor material is shaped or configured as a perimeter, border or surround to a carbon foam component, such a heating element or liquid porous element, to prevent liquid leakage.

10. The method of claim 1 in which the component is a heating element configured to heat evenly and uniformly across its surface.

11. The method of claim 1 in which the component is wettable by e-liquid with a contact angle below 20°.

12. The method of claim 1 in which the component is a heating element with an anti-fouling property.

13. A method of manufacturing a component, made substantially of carbon foam; in which the method includes the step of using a high temperature process generated by a laser beam directed at a carbon pre-cursor material, such as a polymer or polyimide sheet material, to manufacture a carbon foam component that is electrically conductive, and non-metallic;
in which the component is an inductively heated target or susceptor.

14. The method of claim 13 comprising the step of irradiating a sub-surface or encapsulated region of the carbon pre-cursor material, parameters of the laser beam being selected to create a carbon foam in that sub-surface or encapsulated region.

15. The method of claim 13 comprising the step of irradiating an encapsulated, sub-surface region of the carbon pre-cursor material, parameters of the laser beam being selected to create a carbon foam in that region and in which no substantial gas escape pathways to a surface of the pre-cursor material are created by the laser beam.

16. The method of claim 13 comprising the step of irradiating an internal region of the carbon pre-cursor material, positioned on a substrate, parameters of the laser beam being selected to create a carbon foam in that region and to create a disorganised, amorphous, non-graphene material between the carbon foam region and the substrate; in which that disorganised, amorphous, non-graphene material is adhering or otherwise attaching directly to the substrate.

17. The method of claim 13 comprising the steps of (a) a laser beam irradiating an encapsulated or sub-surface region of the carbon pre-cursor material, to create a carbon foam in that encapsulated or sub-surface region and a disorganised, amorphous non-graphene substance above the carbon foam, and then (b) laser ablation or treatment to remove the disorganised, amorphous non-graphene substance and to expose at least some of the carbon foam.

18. The method of claim 13 comprising the steps of (a) a laser beam irradiating an encapsulated or sub-surface region of the carbon pre-cursor material to create a carbon foam in that encapsulated or sub-surface region in the carbon pre-cursor material, and a disorganised, amorphous non-graphene substance above the carbon foam and then (b) laser ablation or treatment to remove the disorganised, amorphous non-graphene substance and expose at least some of the underlying carbon foam and transform at least some of that underlying carbon foam into a non-graphene carbon foam.

19. The method of claim 13 comprising the steps of (a) using a laser beam operating at a first band to irradiate an encapsulated or sub-surface region of the carbon pre-cursor material below a surface of the material, to create carbon foam in that encapsulated or sub-surface region, and then (b) using a laser beam operating at a second band to remove or ablate material sitting above the carbon foam, to expose and/or transform at least some of the carbon foam.

20. The method of claim 13 comprising the steps:
(a) using a laser beam operating at a first band to irradiate an encapsulated or sub-surface region of the carbon pre-cursor material below a surface of the material, to create carbon foam in that encapsulated or sub-surface region, and then
(b) using a laser beam operating at a second band to remove or ablate material sitting above the carbon foam, to expose and/or transform at least some of the carbon foam;
and where the carbon foam is at least 50 μm in thickness or depth.

21. The method of claim 13 in which the method includes passing a continuous reel of the carbon pre-cursor film through a sequence of operations required to manufacture the carbon foam component.

22. The method of claim 13 in which the target or susceptor is configured to heat evenly and uniformly across its surface.

23. A method of manufacturing a component made substantially of carbon foam, in which the method includes the step of using a high temperature process generated by a laser beam directed at a carbon-based pre-cursor material, such as a polymer or polyimide sheet material, to manufacture a carbon foam component; the method including the step of:
modulating laser parameters in real-time to create adjacent zones with different, functionally-optimized properties, such as porosity and electrical resistivity, within a single monolithic structure.
